(19) United States
(12) Patent Application Publication
(10) Pub. No.: US 2026/0037601 A1
(43) Pub. Date: Feb. 5, 2026

(54) SYSTEM AND METHOD FOR LINKING RECORDS USING MULTI-STAGE MACHINE LEARNING MODELS AND CONTEXTUAL DATA ANALYSIS

(71) Applicant: Ancestry.com Operations Inc., Lehi, UT (US)

(72) Inventors: Benjamin James Busath, Chicago, IL (US); Tsung-Nan Liu, San Francisco, CA (US); Zhila Esna Ashari Esfahani, Pacifica, CA (US); Namrata Sharma, San Francisco, CA (US); Sharon Kim, San Jose, CA (US)

(21) Appl. No.: 19/284,072

(22) Filed: Jul. 29, 2025

Related U.S. Application Data
(60) Provisional application No. 63/677,351, filed on Jul. 30, 2024.

(51) Int. Cl. G06F 18/22; G06N 20/20

(52) U.S. Cl. CPC G06F 18/22; G06N 20/20

(57) ABSTRACT

The present disclosure is directed toward systems, methods, and non-transitory computer-readable media for determining links between source genealogical records and candidate genealogical records. The disclosed systems can apply a first machine learning model to generate embeddings of a set of genealogical records. Further, the disclosed systems can compare the embeddings within a latent space of the first machine learning model to identify embeddings that are within a threshold distance of a source genealogical embedding that corresponds to a source genealogical record. The disclosed systems can further apply a second machine learning model to extract field data from the embeddings, and a third machine learning model to extract contextual data from the embeddings. The disclosed systems can use the field data and contextual data to determine a link between the source genealogical record and a candidate genealogical record.

### CROSS-REFERENCE TO RELATED APPLICATIONS

This application claims the benefit of, and priority to, U.S. Provisional Application No. 63/677,351, entitled “SYSTEM AND METHOD FOR LINKING RECORDS USING MULTI-STAGE MACHINE LEARNING MODELS AND CONTEXTUAL DATA ANALYSIS,” filed Jul. 30, 2024, the contents of which are incorporated by reference herein in their entirety.

### FIELD

The disclosed embodiments relate to genealogical record linking systems and methods, particularly to techniques for identifying and connecting related records across multiple databases using machine learning models and contextual data analysis.

### BACKGROUND

Data-inheritance origins may be referred to as origins and describe how data may be inherited from real-world events. Data may be inherited and evolved based on real-world events that are not always recorded or documented. Yet, while the real-world events may not be completely documented, the change and inheritance of those events may be traceable by comparing data strings among data instances. For example, two data instances may be generated independently and individually reflect the status of their respective named entities or events. The data patterns in the data instances may reflect the natures, histories, or characteristics of data inheritance sources such as related or unrelated named entities or events. However, multiple data instances or corresponding named entities or events may be inherited from one or more common sources so that the data instances share some similarities in the data pattern. As such, the nature of inheritance may be revealed by analyzing and comparing the multiple data instances, and sometimes a large number of data instances. Those real-life events that result in shared data strings among data instances may be referred to as data inheritance events, even though those real-life events, at the time of the occurrence, may not involve data or data generation at all. For example, the real-life events may be historical events that occurred before the invention of computers or data but present data instances may still reflect those historical events. Accordingly, existing genealogical-data systems exhibit a number of technical challenges relating to these problems, particularly in relation to accuracy, operational flexibility, and efficiency.

For example, existing genealogical systems generate inaccurate links between genealogical records, or otherwise fail to generate a link at all. To illustrate, existing systems often rely on heuristic methods of matching field data between sets of records which are often tripped up by mismatched sets (or even slight discrepancies) of field data within genealogical records of a same type of collection (e.g., such as birth certificates) when determining links between candidate genealogical records and source genealogical records. Indeed, as mentioned above, genealogical records vary widely in their formats and completeness across different databases. Additionally, data-inheritance events often do not generate data, or the data they do generate is not uniform across all record types. Thus, existing genealogical systems that rely on matching field data sets or complete field data sets frequently cannot generate links between source genealogical records and target genealogical records without more complete field data.

Additionally, existing genealogical-data systems are operationally inflexible. To illustrate, existing systems often rigidly approach entity resolution by comparing genealogical records of a same collection type (e.g., such as comparing a census record to a census record). In addition to existing genealogical-data systems struggling to account for even slight discrepancies of field data within genealogical records of a same type of collection as mentioned above, existing genealogical-data systems face even more technical challenges trying to compare genealogical records from different collection types due to factors relating to data-inheritance events such as: differences in types of data recorded among different collection types (e.g., death certificates contain different types of information than divorce records); differences in granularity of data recorded among different collection types (e.g., wills can contain more information than death certificates); as well as differences in how the genealogical records, both within and across collection types, were populated by different personnel (e.g., birth certificates are populated differently in different countries and states, and birth certificates are populated differently than death certificates). The inability of existing genealogical-data systems to extract and resolve entities from different types of collections further prevents existing genealogical-data systems from expanding databases, at least reliably. These technical challenges are especially prominent at the margins/edges of existing genealogical databases where existing genealogical-data systems need to discover new links to expand existing genealogical database.

Further, many existing genealogical-data systems are computationally inefficient. Indeed, determining links between source genealogical records and target genealogical records requires analysis and comparison of sets of genealogical records. Existing genealogical systems typically approach this process in a linear, sequential manner, comparing genealogical records one at a time. The iterative nature of such a process can create long processing times and computational overhead in existing systems, resulting in excessive use of computational resources, such as network bandwidth, memory, and processing power.

### SUMMARY

Disclosed herein relates to example embodiments that predict data-source influences on one or more data manifestations of a named entity. The disclosed systems can generate record links between genealogical records using a two-part framework including: 1) a candidate retrieval process whereby the disclosed systems extract and compare record embeddings to determine candidates for linking, and 2) a candidate ranking process whereby the disclosed systems determine links between records based on ranking the identified candidates.

The method includes converting a set of records into embeddings using a first machine learning model. The method compares embeddings of target records to an embedding of a source record in a latent space of the machine learning model. The method identifies a set of candidate records (e.g., a set of candidate genealogical records) based on the comparing. The method applies a second machine learning model to compare field similarities between each candidate record and the source record. The method applies a third machine learning model that considers at least extracted contextual data to measure a likelihood of a match between each candidate record and the source record. The method determines a link between the source record and the target record based on outputs from the second and third machine learning models.

In yet another embodiment, a non-transitory computer-readable medium that is configured to store instructions is described. The instructions, when executed by one or more processors, cause the one or more processors to perform a process that includes steps described in the above computer-implemented methods or described in any embodiments of this disclosure. In yet another embodiment, a system may include one or more processors and a storage medium that is configured to store instructions. The instructions, when executed by one or more processors, cause the one or more processors to perform a process that includes steps described in the above computer-implemented methods or described in any embodiments of this disclosure.

### BRIEF DESCRIPTION OF THE DRAWINGS

FIG. 1 illustrates a diagram of a system environment for a record-linking system in accordance with some embodiments.

FIG. 2 is a block diagram of an architecture of an example computing system that the record-linking system can use in accordance with some embodiments.

FIG. 3 is a flowchart depicting an example process of a record-linking system linking records using multi-stage machine learning models and contextual data analysis, in accordance with some embodiments.

FIG. 4 illustrates a record linking process implemented by the record-linking system in accordance with some embodiments.

FIG. 5 illustrates a record-linking system performing embedding-based candidate selection in the latent space created by the first machine learning model, in accordance with some embodiments.

FIG. 6 illustrates a record-linking system using an ensemble architecture that includes a first machine learning model, a second machine learning model, and a third machine learning model to generate a link in accordance with one or more embodiments.

FIG. 7 illustrates a record-linking system determining a candidate genealogical record from a ranking of composite scores in accordance with one or more embodiments.

FIGS. 8A-8B illustrate a record-linking system identifying contextual data from candidate genealogical records and source genealogical records in accordance with one or more embodiments.

FIGS. 9A-9B illustrate experimental results achieved by experimental embodiments of a record-linking system in accordance with one or more embodiments.

FIG. 10 illustrates an example diagram of a genealogical-data system interfacing with a genealogical database in accordance with one or more embodiments.

FIG. 11 illustrates an example series of acts for determining a link between a source genealogical record and a candidate genealogical record in accordance with one or more embodiments.

FIG. 12 is a block diagram of an example computing device, in accordance with some embodiments.

FIG. 13 illustrates an exemplary computing environment in accordance with one or more embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

The figures (FIGS.) and the following description relate to preferred embodiments by way of illustration only. One of skill in the art may recognize alternative embodiments of the structures and methods disclosed herein as viable alternatives that may be employed without departing from the principles of what is disclosed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Example System Environment

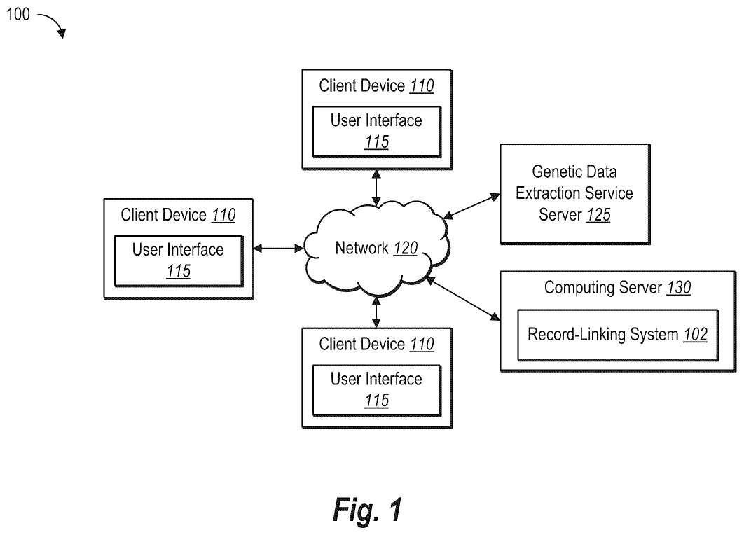

FIG. 1 illustrates a diagram of a system environment 100 of an example computing server 130, in accordance with some embodiments. The system environment 100 can host or otherwise facilitate a record-linking system 102 (e.g., on the computing server 130). Additionally, the system environment 100 shown in FIG. 1 includes one or more client devices 110, a network 120, a genetic data extraction service server 125, and a computing server 130. In various embodiments, the system environment 100 may include fewer or additional components. The system environment 100 may also include different components.

The client devices 110 are one or more computing devices capable of receiving user input as well as transmitting and/or receiving data via a network 120. Example computing devices include desktop computers, laptop computers, personal digital assistants (PDAs), smartphones, tablets, wearable electronic devices (e.g., smartwatches), smart household appliances (e.g., smart televisions, smart speakers, smart home hubs), Internet of Things (IoT) devices or other suitable electronic devices. A client device 110 communicates to other components via the network 120. Users may be customers of the computing server 130 or any individuals who access the system of the computing server 130, such as an online website or a mobile application. In some embodiments, a client device 110 executes an application that launches a graphical user interface (GUI) for a user of the client device 110 to interact with the computing server 130. The GUI may be an example of a user interface 115. A client device 110 may also execute a web browser application to enable interactions between the client device 110 and the computing server 130 via the network 120. In another embodiment, the user interface 115 may take the form of a software application published by the computing server 130 and installed on the user device 110. In yet another embodiment, a client device 110 interacts with the computing server 130 through an application programming interface (API) running on a native operating system of the client device 110, such as IOS or ANDROID.

The network 120 provides connections to the components of the system environment 100 through one or more sub-networks, which may include any combination of local area and/or wide area networks, using both wired and/or wireless communication systems. In some embodiments, a network 120 uses standard communications technologies and/or protocols. For example, a network 120 may include communication links using technologies such as Ethernet, 802.11, worldwide interoperability for microwave access (WiMAX), 3G, 4G, Long Term Evolution (LTE), 5G, code division multiple access (CDMA), digital subscriber line (DSL), etc. Examples of network protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over a network 120 may be represented using any suitable format, such as hypertext markup language (HTML) or extensible markup language (XML). In some embodiments, all or some of the communication links of a network 120 may be encrypted using any suitable technique or techniques such as secure sockets layer (SSL), transport layer security (TLS), virtual private networks (VPNs), Internet Protocol security (IPsec), etc. The network 120 also includes links and packet-switching networks such as the Internet.

Individuals, who may be customers of a company operating the computing server 130, provide biological samples for analysis of their genetic data. Individuals may also be referred to as users. In some embodiments, an individual uses a sample collection kit to provide a biological sample (e.g., saliva, blood, hair, tissue) from which genetic data is extracted and determined according to nucleotide processing techniques such as microarray, amplification and/or sequencing. Microarray may include immobilizing probe DNA sequences, onto a solid surface such as a glass slide. Target DNA samples, labeled with fluorescent tags, are then applied to the microarray surface. Through complementary base pairing, the labeled DNA binds to its corresponding probe on the microarray. By detecting the fluorescence emitted by the labeled DNA, genetic data may be extracted. Amplification may include using polymerase chain reaction (PCR) to amplify segments of nucleotide samples. Sequencing may include sequencing of deoxyribonucleic acid (DNA) sequencing, ribonucleic acid (RNA) sequencing, etc. Suitable sequencing techniques may include Sanger sequencing and massively parallel sequencing such as various next-generation sequencing (NGS) techniques including whole genome sequencing, pyrosequencing, sequencing by synthesis, sequencing by ligation, and ion semiconductor sequencing. In some embodiments, a set of SNPs (e.g., 300,000) that are shared between different array platforms (e.g., Illumina OmniExpress Platform and Illumina HumanHap 650Y Platform) may be obtained as genetic data. Genetic data extraction service server 125 receives biological samples from users of the computing server 130. The genetic data extraction service server 125 extracts genetic data from the samples and the data may take the form of a set of SNPs. The genetic data extraction service server 125 generates the genetic data of the individuals based on sequencing or microarray results. The genetic data may include data generated from DNA or RNA and may include base pairs from coding and/or noncoding regions of DNA.

The genetic data may take different forms and include information regarding various biomarkers of an individual. For example, in some embodiments, the genetic data may be the base pair sequence of an individual. The base pair sequence may include the whole genome or a part of the genome such as certain genetic loci of interest. In another embodiment, the genetic data extraction service server 125 may determine genotypes from DNA identification results, for example by identifying genotype values of single nucleotide polymorphisms (SNPs) present within the DNA. The results in this example may include a sequence of genotypes corresponding to various SNP sites. A SNP site may also be referred to as a SNP locus. A genetic locus is a segment of a genetic sequence. A locus can be a single site or a longer stretch. The segment can be a single base long or multiple bases long. In some embodiments, the genetic data extraction service server 125 may perform data pre-processing of the genetic data to convert raw sequences of base pairs to sequences of genotypes at or genotyping data of target SNP sites. Since a typical human genome may differ from a reference human genome at only several million SNP sites (as opposed to billions of base pairs in the whole genome), the genetic data extraction service server 125 may extract only the genotypes at or genotyping data of a set of target SNP sites and transmit the extracted data to the computing server 130 as the inheritance dataset of an individual. SNPs, base pair sequences, genotypes, haplotypes, RNA sequences, protein sequences, and phenotypes are examples of biomarkers. In some embodiments, each SNP site may have two readings that are heterozygous.

The computing server 130 performs various analyses of the genetic data, genealogy data, and users' survey responses to generate results regarding the phenotypes and genealogy of users of computing server 130. Depending on the embodiments, the computing server 130 may also be referred to as an online server, a personal genetic service server, a genealogy server, a family tree building server, and/or a social networking system. The computing server 130 receives genetic data from the genetic data extraction service server 125 and stores the genetic data in the data store of the computing server 130. The computing server 130 may analyze the data to generate results regarding the genetics or genealogy of users. The results regarding the genetics or genealogy of users may include the ethnicity compositions of users, paternal and maternal genetic analysis, identification or suggestion of potential family relatives, ancestor information, analyses of DNA data, potential or identified traits such as phenotypes of users (e.g., diseases, appearance traits, other genetic characteristics, and other non-genetic characteristics including social characteristics), etc. The computing server 130 may present or cause the user interface 115 to present the results to the users through a GUI displayed on the client device 110. The results may include graphical elements, textual information, data, charts, and other elements such as family trees.

In some embodiments, the computing server 130 also allows various users to create one or more genealogical profiles of the user. The genealogical profile may include a list of individuals (e.g., ancestors, relatives, friends, and other people of interest) who are added or selected by the user or suggested by the computing server 130 based on the genealogical records and/or genetic records. The user interface 115 controlled by or in communication with the computing server 130 may display the individuals in a list or as a family tree such as in the form of a pedigree chart. In some embodiments, subject to the user's privacy setting and authorization, the computing server 130 may allow information generated from the user's inheritance dataset to be linked to the user profile and to one or more of the family trees. The users may also authorize the computing server 130 to analyze their inheritance dataset and allow their profiles to be discovered by other users.

As suggested above, the record-linking system 102 provides several improvements over conventional systems. For example, the record-linking system 102 can improve accuracy over prior systems. By using a two-phase ensemble framework that includes: 1) a specialized candidate retrieval process using a finetuned deep learning model (e.g., SBERT) for nearest neighbor searching and 2) a ranking process that is made up of two additional machine learning models (one for generating scores for general record links and another for generating scores for contextual record links), the record-linking system 102 is able to account for (or be robust to) incomplete, sparse, or underrepresented data within records (while still generating accurate predictions of record links). Specifically, by performing a nearest neighbor search among embeddings extracted and compared using the described machine learning model, the record-linking system 102 accurately identifies links among candidate genealogical records, even among records with sparse, incomplete, or underrepresented data. Further, by implementing the second phase of identifying links at the general (e.g., database-wide or collection-wide) level and the contextual level using respective models robustly tuned for these purposes, the record-linking system 102 can identify record links that heuristics-based systems would have otherwise missed.

Relating to the accuracy improvements, the record-linking system 102 can improve operational flexibility compared to prior systems. Indeed, rather than relying on heuristics-based methods which are rigidly adherent to particular record types, formats, and/or completeness of genealogical records, the record-linking system 102 is adaptive to a variety of record types, formats, and completeness levels (while still achieving better accuracy in link generation). Comparing genealogical records using the two-phase ensemble framework (e.g., a two-phase machine learning framework) of the record-linking system 102 shifts the paradigm of record analysis from a binary approach of comparing field by field (indicating match or no match at each field) often implemented by prior systems to a more holistic and intelligent comparison method that can interpret (rather than exclude) differences in field data as part of the link-prediction process. Additionally, rather than implementing heuristics-based matching which does not account for contextual data to inform link prediction, the record-linking system 102 can identify and consider contextual data between genealogical records to inform record link prediction.

Additionally, the record-linking system 102 can improve operational flexibility compared to prior systems by facilitating collection-agnostic record linking. As discussed above, prior systems struggle to overcome technical challenges associated with linking genealogical records of different types of collections (for example such as a birth certificate and a census record). Additionally, prior systems struggle to identify data-inheritance events due to factors such as variance in types of data across types of collections and granularity of data across different types of collections. Conversely, the record-linking system 102 can implement a two-phase ensemble framework to identify and compare contextual data corresponding to the genealogical records of different collections. By using the two-phase ensemble framework to identify the contextual data, the record-linking system 102 can extract entities from different types of genealogical record collections. The record-linking system 102 can further use the two-phase ensemble framework to resolve the extracted entities (e.g., such as by linking a first entity from a first record collection type and a second entity from a second record collection type). By comparing genealogical records from different collection types, the record-linking system 102 can identify data-inheritance events across different types of collections, thus facilitating the expansion of backbones of genealogical databases along margins/edges of the genealogical database by extracting entities from different types of collections of genealogical records and generating new links between the entities along the margins/edges of existing genealogical databases.

Further, the record-linking system 102 improves computational efficiency compared to conventional systems. Indeed, rather than comparing genealogical records in a linear, sequential manner, the record-linking system 102 can compare multiple target genealogical records to a source genealogical record in parallel, thus reducing processing time and computational overhead relative to iterative methods. Specifically, the record-linking system 102 implements an ensemble architecture that includes a first machine learning model for identifying candidate records, a second machine learning model for generating link scores on a general level, and a third machine learning model for generating link scores on a contextual level. In some cases, through the ensemble architecture, the record-linking system 102 can parallelly apply the second and third machine learning models to generate respective scores for combining into an ultimate link prediction-thus providing improved processing speeds compared to systems that would otherwise process in series.

Through the process of predicting record links among genealogical records, the record-linking system 102 can provide functionality not found in prior systems, resulting in much more robust database of genealogical records. To elaborate, the record-linking system 102 can create a traceable path of genealogical records through time and space (e.g., across geographic locations) by linking records together based on corresponding to the same person, place, or event. In some cases, the record-linking system 102 creates (using the processes described herein) an initial record backbone of census records because census records are reliable (e.g., each person appears only a single time) and regularly gathered and are therefore readily comparable. From the backbone of census records, the record-linking system 102 further stitches (using the processes described herein) to the backbone additional records from other collections or databases of genealogical records. The record-linking system 102 can thus generate a reliable and traceable record chain of records across databases to ascertain timing and location relationships among the records and the entities (e.g., people, places, and events) referenced therein or associated thereto.

### Example Computing Server Architecture

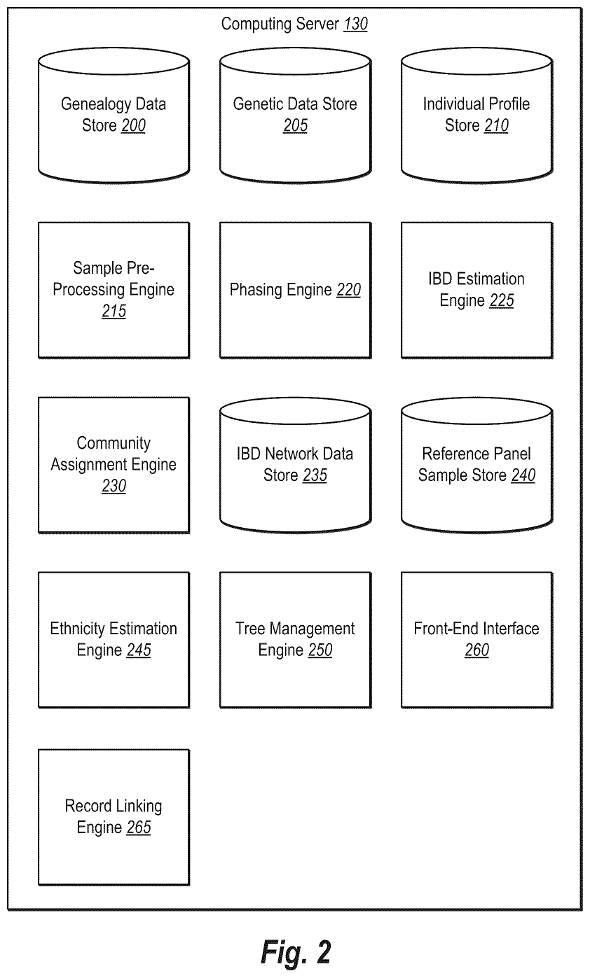

FIG. 2 is a block diagram of the architecture of an example computing server 130 (e.g., housing the record-linking system 102 and additional components accessible by the record-linking system 102) in accordance with some embodiments. In the embodiment shown in FIG. 2, the computing server 130 includes a genealogy data store 200, a genetic data store 205, an individual profile store 210, a sample pre-processing engine 215, a phasing engine 220, an identity by descent (IBD) estimation engine 225, a community assignment engine 230, an IBD network data store 235, a reference panel sample store 240, an ethnicity estimation engine 245, a tree management engine 250, a front-end interface 260, and a record linking engine 265. The functions of the computing server 130 may be distributed among the elements in a different manner than described. In various embodiments, the computing server 130 may include different components and fewer or additional components. Each of the various data stores may be a single storage device, a server controlling multiple storage devices, or a distributed network that is accessible through multiple nodes (e.g., a cloud storage system).

The computing server 130 stores various data of different individuals, including genetic data, genealogy data, and survey response data. The computing server 130 processes the genetic data of users to identify shared identity-by-descent (IBD) segments between individuals. The genealogy data and survey response data may be part of user profile data. The amount and type of user profile data stored for each user may vary based on the information of a user, which is provided by the user as she creates an account and profile at a system operated by the computing server 130 and continues to build her profile, family tree, and social network at the system and to link her profile with her genetic data. Users may provide data via the user interface 115 of a client device 110. Initially and as a user continues to build her genealogical profile, the user may be prompted to answer questions related to the basic information of the user (e.g., name, date of birth, birthplace, etc.) and later on more advanced questions that may be useful for obtaining additional genealogy data. The computing server 130 may also include survey questions regarding various traits of the users such as the users' phenotypes, characteristics, preferences, habits, lifestyle, environment, etc.

Genealogy data may be stored in the genealogy data store 200 and may include various types of data that are related to tracing family relatives of users. Examples of genealogy data include names (first, last, middle, suffixes), gender, birth locations, date of birth, date of death, marriage information, spouse's information kinships, family history, dates and places for life events (e.g., birth and death), other vital data, and the like. In some instances, family history can take the form of a pedigree of an individual (e.g., the recorded relationships in the family). The family tree information associated with an individual may include one or more specified nodes. Each node in the family tree represents the individual, an ancestor of the individual who might have passed down genetic material to the individual, and the individual's other relatives including siblings, cousins, and offspring in some cases. Genealogy data may also include connections and relationships among users of the computing server 130. The information related to the connections between a user and her relatives that may be associated with a family tree may also be referred to as pedigree data or family tree data.

In addition to user-input data, genealogy data may also take other forms that are obtained from various sources such as public records and third-party data collectors. For example, genealogical records from public sources include birth records, marriage records, death records, census records, court records, probate records, adoption records, obituary records, etc. Likewise, genealogy data may include data from one or more family trees of an individual, the Ancestry World Tree system, a Social Security Death Index database, the World Family Tree system, a birth certificate database, a death certificate database, a marriage certificate database, an adoption database, a draft registration database, a veterans database, a military database, a property records database, a census database, a voter registration database, a phone database, an address database, a newspaper database, an immigration database, a family history records database, a local history records database, a business registration database, a motor vehicle database, and the like.

Furthermore, the genealogy data store 200 may also include relationship information inferred from the genetic data stored in the genetic data store 205 and information received from the individuals. For example, the relationship information may indicate which individuals are genetically related, how they are related, how many generations back they share common ancestors, lengths and locations of IBD segments shared, which genetic communities an individual is a part of, variants carried by the individual, and the like.

The computing server 130 maintains inheritance datasets of individuals in the genetic data store 205. An inheritance dataset of an individual may be a digital dataset of nucleotide data (e.g., SNP data) and corresponding metadata. For example, an inheritance dataset may be genetic data extracted by the genetic data extraction service server 125. An inheritance dataset may contain data on the whole or portions of an individual's genome. The genetic data store 205 may store a pointer to a location associated with the genealogy data store 200 associated with the individual. An inheritance dataset may take different forms. In some embodiments, an inheritance dataset may take the form of a base pair sequence of the sequencing result of an individual. A base pair sequence dataset may include the whole genome of the individual (e.g., obtained from a whole-genome sequencing) or some parts of the genome (e.g., genetic loci of interest). A microarray data may take the form of SNP data at target positions in the genome.

In another embodiment, an inheritance dataset may take the form of sequences of genetic markers. Examples of genetic markers may include target SNP sites (e.g., allele sites) filtered from the DNA identification results. A SNP site that is a single base pair long may also be referred to as a SNP locus. A SNP site may be associated with a unique identifier. The inheritance dataset may be in the form of diploid data that includes a sequence of genotypes, such as genotypes at or genotyping data of the target SNP site, or the whole base pair sequence that includes genotypes at or genotyping data of known SNP sites and other base pair sites that are not commonly associated with known SNPs. The diploid dataset may be referred to as a genotype dataset or a genotype sequence. Genotype may have a different meaning in various contexts. In one context, an individual's genotype may refer to a collection of diploid alleles of an individual. In other contexts, a genotype may be a pair of alleles present on two chromosomes for an individual at a given genetic marker such as a SNP site.

Genotype data for a SNP site may include a pair of alleles. The pair of alleles may be homozygous (e.g., A-A or G-G) or heterozygous (e.g., A-T, C-T). Instead of storing the actual nucleotides, the genetic data store 205 may store genetic data that are converted to bits. For a given SNP site, oftentimes only two nucleotide alleles (instead of all 4) are observed. As such, a 2-bit number may represent a SNP site. For example, 00 may represent homozygous first alleles, 11 may represent homozygous second alleles, and 01 or 10 may represent heterozygous alleles. A separate library may store what nucleotide corresponds to the first allele and what nucleotide corresponds to the second allele at a given SNP site.

A diploid dataset may also be phased into two sets of haploid data, one corresponding to a first parent side and another corresponding to a second parent side. The phased datasets may be referred to as haplotype datasets or haplotype sequences. Similar to genotype, haplotype may have a different meaning in various contexts. In one context, a haplotype may also refer to a collection of alleles that corresponds to a genetic segment. In other contexts, a haplotype may refer to a specific allele at a SNP site. For example, a sequence of haplotypes may refer to a sequence of alleles of an individual that are inherited from a parent.

The individual profile store 210 stores profiles and related metadata associated with various individuals appeared in the computing server 130. A computing server 130 may use unique individual identifiers to identify various users and other non-users that might appear in other data sources such as ancestors or historical persons who appear in any family tree or genealogy database. A unique individual identifier may be a hash of certain identification information of an individual, such as a user's account name, user's name, date of birth, location of birth, or any suitable combination of the information. The profile data related to an individual may be stored as metadata associated with an individual's profile. For example, the unique individual identifier and the metadata may be stored as a key-value pair using the unique individual identifier as a key.

An individual's profile data may include various kinds of information related to the individual. The metadata about the individual may include one or more pointers associating inheritance datasets such as genotype and phased haplotype data of the individual that are saved in the genetic data store 205. The metadata about the individual may also be individual information related to family trees and pedigree datasets that include the individual. The profile data may further include declarative information about the user that was authorized by the user to be shared and may also include information inferred by the computing server 130. Other examples of information stored in a user profile may include biographic, demographic, and other types of descriptive information such as work experience, educational history, gender, hobbies, preferences, location and the like. In some embodiments, the user profile data may also include one or more photos of the users and photos of relatives (e.g., ancestors) of the users that are uploaded by the users. A user may authorize the computing server 130 to analyze one or more photos to extract information, such as the user's or relative's appearance traits (e.g., blue eyes, curved hair, etc.), from the photos. The appearance traits and other information extracted from the photos may also be saved in the profile store. In some cases, the computing server may allow users to upload many different photos of the users, their relatives, and even friends. User profile data may also be obtained from other suitable sources, including historical records (e.g., records related to an ancestor), medical records, military records, photographs, other records indicating one or more traits, and other suitable recorded data.

For example, the computing server 130 may present various survey questions to its users from time to time. The responses to the survey questions may be stored at individual profile store 210. The survey questions may be related to various aspects of the users and the users' families. Some survey questions may be related to users' phenotypes, while other questions may be related to the environmental factors of the users.

Survey questions may concern health or disease-related phenotypes, such as questions related to the presence or absence of genetic diseases or disorders, inheritable diseases or disorders, or other common diseases or disorders that have a family history as one of the risk factors, questions regarding any diagnosis of increased risk of any diseases or disorders, and questions concerning wellness-related issues such as a family history of obesity, family history of causes of death, etc. The diseases identified by the survey questions may be related to single-gene diseases or disorders that are caused by a single-nucleotide variant, an insertion, or a deletion. The diseases identified by the survey questions may also be multifactorial inheritance disorders that may be caused by a combination of environmental factors and genes. Examples of multifactorial inheritance disorders may include heart disease, Alzheimer's disease, diabetes, cancer, and obesity. The computing server 130 may obtain data on a user's disease-related phenotypes from survey questions about the health history of the user and her family and also from health records uploaded by the user.

Survey questions also may be related to other types of phenotypes such as appearance traits of the users. A survey regarding appearance traits and characteristics may include questions related to eye color, iris pattern, freckles, chin types, finger length, dimple chin, earlobe types, hair color, hair curl, skin pigmentation, susceptibility to skin burn, bitter taste, male baldness, baldness pattern, presence of unibrow, presence of wisdom teeth, height, and weight. A survey regarding other traits also may include questions related to users' taste and smell such as the ability to taste bitterness, asparagus smell, cilantro aversion, etc. A survey regarding traits may further include questions related to users' body conditions such as lactose tolerance, caffeine consumption, malaria resistance, norovirus resistance, muscle performance, alcohol flush, etc. Other survey questions regarding a person's physiological or psychological traits may include vitamin traits and sensory traits such as the ability to sense an asparagus metabolite. Traits may also be collected from historical records, electronic health records and electronic medical records.

The computing server 130 also may present various survey questions related to the environmental factors of users. In this context, an environmental factor may be a factor that is not directly connected to the genetics of the users. Environmental factors may include users' preferences, habits, and lifestyles. For example, a survey regarding users' preferences may include questions related to things and activities that users like or dislike, such as types of music a user enjoys, dancing preference, party-going preference, certain sports that a user plays, video game preferences, etc. Other questions may be related to the users' diet preferences such as like or dislike a certain type of food (e.g., ice cream, egg). A survey related to habits and lifestyle may include questions regarding smoking habits, alcohol consumption and frequency, daily exercise duration, sleeping habits (e.g., morning person versus night person), sleeping cycles and problems, hobbies, and travel preferences. Additional environmental factors may include diet amount (calories, macronutrients), physical fitness abilities (e.g., stretching, flexibility, heart rate recovery), family type (adopted family or not, has siblings or not, lived with extended family during childhood), property and item ownership (has home or rents, has a smartphone or doesn't, has a car or doesn't).

Surveys also may be related to other environmental factors such as geographical, social-economic, or cultural factors. Geographical questions may include questions related to the birth location, family migration history, town, or city of users' current or past residence. Social-economic questions may be related to users' education level, income, occupations, self-identified demographic groups, etc. Questions related to culture may concern users' native language, language spoken at home, customs, dietary practices, etc. Other questions related to users' cultural and behavioral questions are also possible.

For any survey questions asked, the computing server 130 may also ask an individual the same or similar questions regarding the traits and environmental factors of the ancestors, family members, other relatives or friends of the individual. For example, a user may be asked about the native language of the user and the native languages of the user's parents and grandparents. A user may also be asked about the health history of his or her family members.

In addition to storing the survey data in the individual profile store 210, the computing server 130 may store some responses that correspond to data related to genealogical and genetics respectively to genealogy data store 200 and genetic data store 205.

The user profile data, photos of users, survey response data, the genetic data, and the genealogy data may be subject to the privacy and authorization setting of the users to specify any data related to the users that can be accessed, stored, obtained, or otherwise used. For example, when presented with a survey question, a user may select to answer or skip the question. The computing server 130 may present users from time to time information regarding users' selection of the extent of information and data shared. The computing server 130 also may maintain and enforce one or more privacy settings for users in connection with the access of the user profile data, photos, genetic data, and other sensitive data. For example, the user may pre-authorize the access to the data and may change the setting as wished. The privacy settings also may allow a user to specify (e.g., by opting out, by not opting in) whether the computing server 130 may receive, collect, log, or store particular data associated with the user for any purpose. A user may restrict her data at various levels. For example, on one level, the data may not be accessed by the computing server 130 for purposes other than displaying the data in the user's own profile. On another level, the user may authorize anonymization of her data and participate in studies and research conducted by the computing server 130 such as a large-scale genetic study. On yet another level, the user may turn some portions of her genealogy data public to allow the user to be discovered by other users (e.g., potential relatives) and be connected to one or more family trees. Access or sharing of any information or data in the computing server 130 may also be subject to one or more similar privacy policies. A user's data and content objects in the computing server 130 may also be associated with different levels of restriction. The computing server 130 may also provide various notification features to inform and remind users of their privacy and access settings. For example, when privacy settings for a data entry allow a particular user or other entities to access the data, the data may be described as being “visible,” “public,” or other suitable labels, contrary to a “private” label.

In some cases, the computing server 130 may have heightened privacy protection on certain types of data and data related to certain vulnerable groups. In some cases, the heightened privacy settings may strictly prohibit the use, analysis, and sharing of data related to a certain vulnerable group. In other cases, the heightened privacy settings may specify that data subject to those settings require prior approval for access, publication, or other use. In some cases, the computing server 130 may provide heightened privacy as a default setting for certain types of data, such as genetic data or any data that the user marks as sensitive. The user may opt in to sharing those data or change the default privacy settings. In other cases, the heightened privacy settings may apply across the board for all data of certain groups of users. For example, if computing server 130 determines that the user is a minor or has recognized that a picture of a minor is uploaded, the computing server 130 may designate all profile data associated with the minor as sensitive. In those cases, the computing server 130 may have one or more extra steps in seeking and confirming any sharing or use of the sensitive data.

In some embodiments, the individual profile store 210 may be a large-scale data store. In some embodiments, the individual profile store 210 may include at least 10,000 data records in the form of user profiles and each user profile may be associated with one or more inheritance datasets and one or more genealogical data entries. In some embodiments, the individual profile store 210 may include at least 50,000 data records in the form of user profiles and each user profile may be associated with one or more inheritance datasets and one or more genealogical data entries. In some embodiments, the individual profile store 210 may include at least 100,000 data records in the form of user profiles and each user profile may be associated with one or more inheritance datasets and one or more genealogical data entries. In some embodiments, the individual profile store 210 may include at least 500,000 data records in the form of user profiles and each user profile may be associated with one or more inheritance datasets and one or more genealogical data entries. In some embodiments, the individual profile store 210 may include at least 1,000,000 data records in the form of user profiles and each user profile may be associated with one or more inheritance datasets and one or more genealogical data entries. In some embodiments, the individual profile store 210 may include at least 2,000,000 data records in the form of user profiles and each user profile may be associated with one or more inheritance datasets and one or more genealogical data entries. In some embodiments, the individual profile store 210 may include at least 5,000,000 data records in the form of user profiles and each user profile may be associated with one or more inheritance datasets and one or more genealogical data entries. In some embodiments, the individual profile store 210 may include at least 10,000,000 data records in the form of user profiles and each user profile may be associated with one or more inheritance datasets and one or more genealogical data entries.

The sample pre-processing engine 215 receives and pre-processes data received from various sources to change the data into a format used by the computing server 130. For genealogy data, the sample pre-processing engine 215 may receive data from an individual via the user interface 115 of the client device 110. To collect the user data (e.g., genealogical and survey data), the computing server 130 may cause an interactive user interface on the client device 110 to display interface elements in which users can provide genealogy data and survey data. Additional data may be obtained from scans of public records. The data may be manually provided or automatically extracted via, for example, optical character recognition (OCR) performed on census records, town or government records, or any other item of printed or online material. Some records may be obtained by digitalizing written records such as older census records, birth certificates, death certificates, etc.

The sample pre-processing engine 215 may also receive raw data from the genetic data extraction service server 125. The genetic data extraction service server 125 may perform laboratory analysis of biological samples of users and generate sequencing results in the form of digital data. The sample pre-processing engine 215 may receive the raw inheritance datasets from the genetic data extraction service server 125. Most of the mutations that are passed down to descendants are related to single-nucleotide polymorphism (SNP). SNP is a substitution of a single nucleotide that occurs at a specific position in the genome. The sample pre-processing engine 215 may convert the raw base pair sequence into a sequence of genotypes of target SNP sites. Alternatively, the pre-processing of this conversion may be performed by the genetic data extraction service server 125. The sample pre-processing engine 215 identifies autosomal SNPs in an individual's inheritance dataset. In some embodiments, the SNPs may be autosomal SNPs. In some embodiments, 700,000 SNPs may be identified in an individual's data and may be stored in genetic data store 205. Alternatively, in some embodiments, an inheritance dataset may include at least 10,000 SNP sites. In another embodiment, an inheritance dataset may include at least 100,000 SNP sites. In yet another embodiment, an inheritance dataset may include at least 300,000 SNP sites. In yet another embodiment, an inheritance dataset may include at least 1,000,000 SNP sites. The sample pre-processing engine 215 may also convert the nucleotides into bits. The identified SNPs, in bits or in other suitable formats, may be provided to the phasing engine 220 which phases the individual's diploid genotypes to generate a pair of haplotypes for each user.

The phasing engine 220 phases a diploid inheritance dataset into a pair of haploid inheritance datasets and may perform imputation of SNP values at certain sites whose alleles are missing. An individual's haplotype may refer to a collection of alleles (e.g., a sequence of alleles) that are inherited from a parent.

Phasing may include a process of determining the assignment of alleles (particularly heterozygous alleles) to chromosomes. Owing to conditions and other constraints in sequencing or microarray, a DNA identification result often includes data regarding a pair of alleles at a given SNP locus of a pair of chromosomes but may not be able to distinguish which allele belongs to which specific chromosome. The phasing engine 220 uses a genotype phasing algorithm to assign one allele to a first chromosome and another allele to another chromosome. The genotype phasing algorithm may be developed based on an assumption of linkage disequilibrium (LD), which states that haplotype in the form of a sequence of alleles tends to cluster together. The phasing engine 220 is configured to generate phased sequences that are also commonly observed in many other samples. Put differently, haplotype sequences of different individuals tend to cluster together. A haplotype-cluster model may be generated to determine the probability distribution of a haplotype that includes a sequence of alleles. The haplotype-cluster model may be trained based on labeled data that includes known phased haplotypes from a trio (parents and a child). A trio is used as a training sample because the correct phasing of the child is almost certain by comparing the child's genotypes to the parent's inheritance datasets. The haplotype-cluster model may be generated iteratively along with the phasing process with a large number of unphased genotype datasets. The haplotype-cluster model may also be used to impute one or more missing data.

By way of example, the phasing engine 220 may use a directed acyclic graph model such as a hidden Markov model (HMM) to perform the phasing of a target genotype dataset. The directed acyclic graph may include multiple levels, each level having multiple nodes representing different possibilities of haplotype clusters. An emission probability of a node, which may represent the probability of having a particular haplotype cluster given an observation of the genotypes may be determined based on the probability distribution of the haplotype-cluster model. A transition probability from one node to another may be initially assigned to a non-zero value and be adjusted as the directed acyclic graph model and the haplotype-cluster model are trained. Various paths are possible in traversing different levels of the directed acyclic graph model. The phasing engine 220 determines a statistically likely path, such as the most probable path or a probable path that is at least more likely than 95% of other possible paths, based on the transition probabilities and the emission probabilities. A suitable dynamic programming algorithm such as the Viterbi algorithm may be used to determine the path. The determined path may represent the phasing result. U.S. Pat. No. 10,679,729, entitled “Haplotype Phasing Models,” granted on Jun. 9, 2020, describes example embodiments of haplotype phasing.

A phasing algorithm may also generate phasing result that has a long genomic distance accuracy and cross-chromosome accuracy in terms of haplotype separation. For example, in some embodiments, an IBD-phasing algorithm may be used, which is described in further detail in U.S. Patent Application Publication No. US 2021/0034647, entitled “Clustering of Matched Segments to Determine Linkage of Dataset in a Database,” published on Feb. 4, 2021. For example, the computing server 130 may receive a target individual genotype dataset and a plurality of additional individual genotype datasets that include haplotypes of additional individuals. For example, the additional individuals may be reference panels or individuals who are linked (e.g., in a family tree) to the target individual. The computing server 130 may generate a plurality of sub-cluster pairs of first parental groups and second parental groups. Each sub-cluster pair may be in a window. The window may correspond to a genomic segment and has a similar concept of window used in the ethnicity estimation engine 245 and the rest of the disclosure related to HMMs, but how windows are precisely divided and defined may be the same or different in the phasing engine 220 and in an HMM. Each sub-cluster pair may correspond to a genetic locus. In some embodiments, each sub-cluster pair may have a first parental group that includes a first set of matched haplotype segments selected from the plurality of additional individual datasets and a second parental group that includes a second set of matched haplotype segments selected from the plurality of additional individual datasets. The computing server 130 may generate a super-cluster of a parental side by linking the first parental groups and the second parental groups across a plurality of genetic loci (across a plurality of sub-cluster pairs). Generating the super-cluster of the parental side may include generating a candidate parental side assignment of parental groups across a set of sub-cluster pairs that represent a set of genetic loci in the plurality of genetic loci. The computing server 130 may determine the number of common additional individual genotype datasets that are classified in the candidate parental side assignment. The computing server 130 may determine the candidate parental side assignment to be part of the super-cluster based on the number of common additional individual genotype datasets. Any suitable algorithms may be used to generate the super-cluster, such as a heuristic scoring approach, a bipartite graph approach, or another suitable approach. The computing server 130 may generate a haplotype phasing of the target individual from the super-cluster of the parental side.

The IBD estimation engine 225 estimates the amount of shared genetic segments between a pair of individuals based on phased genotype data (e.g., haplotype datasets) that are stored in the genetic data store 205. IBD segments may be segments identified in a pair of individuals that are putatively determined to be inherited from a common ancestor. The IBD estimation engine 225 retrieves a pair of haplotype datasets for each individual. The IBD estimation engine 225 may divide each haplotype dataset sequence into a plurality of windows. Each window may include a fixed number of SNP sites (e.g., about 100 SNP sites). The IBD estimation engine 225 identifies one or more seed windows in which the alleles at all SNP sites in at least one of the phased haplotypes between two individuals are identical. The IBD estimation engine 225 may expand the match from the seed windows to nearby windows until the matched windows reach the end of a chromosome or until a homozygous mismatch is found, which indicates the mismatch is not attributable to potential errors in phasing or imputation. The IBD estimation engine 225 determines the total length of matched segments, which may also be referred to as IBD segments. The length may be measured in the genetic distance in the unit of centimorgans (cM). A unit of centimorgan may be a genetic length. For example, two genomic positions that are one cM apart may have a 1% chance during each meiosis of experiencing a recombination event between the two positions. The computing server 130 may save data regarding individual pairs who share a length of IBD segments exceeding a predetermined threshold (e.g., 6 cM), in a suitable data store such as in the genealogy data store 200. U.S. Pat. No. 10,114,922, entitled “Identifying Ancestral Relationships Using a Continuous stream of Input,” granted on Oct. 30, 2018, and U.S. Pat. No. 10,720,229, entitled “Reducing Error in Predicted Genetic Relationships,” granted on Jul. 21, 2020, describe example embodiments of IBD estimation.

Typically, individuals who are closely related share a relatively large number of IBD segments, and the IBD segments tend to have longer lengths (individually or in aggregate across one or more chromosomes). In contrast, individuals who are more distantly related share relatively fewer IBD segments, and these segments tend to be shorter (individually or in aggregate across one or more chromosomes). For example, while close family members often share upwards of 71 cM of IBD (e.g., third cousins), more distantly related individuals may share less than 12 cM of IBD. The extent of relatedness in terms of IBD segments between two individuals may be referred to as IBD affinity. For example, the IBD affinity may be measured in terms of the length of IBD segments shared between two individuals.

Community assignment engine 230 assigns individuals to one or more genetic communities based on the genetic data of the individuals. A genetic community may correspond to an ethnic origin or a group of people descended from a common ancestor. The granularity of genetic community classification may vary depending on embodiments and methods used to assign communities. For example, in some embodiments, the communities may be African, Asian, European, etc. In another embodiment, the European community may be divided into Irish, German, Swedes, etc. In yet another embodiment, the Irish may be further divided into Irish in Ireland, Irish who immigrated to America in 1800, Irish who immigrated to America in 1900, etc. The community classification may also depend on whether a population is admixed or unadmixed. For an admixed population, the classification may further be divided based on different ethnic origins in a geographical region.

Community assignment engine 230 may assign individuals to one or more genetic communities based on their inheritance datasets using machine learning models trained by unsupervised learning or supervised learning. In an unsupervised approach, the community assignment engine 230 may generate data representing a partially connected undirected graph. In this approach, the community assignment engine 230 represents individuals as nodes. Some nodes are connected by edges whose weights are based on IBD affinity between two individuals represented by the nodes. For example, if the total length of two individuals' shared IBD segments does not exceed a predetermined threshold, the nodes are not connected. The edges connecting two nodes are associated with weights that are measured based on the IBD affinities. The undirected graph may be referred to as an IBD network. The community assignment engine 230 uses clustering techniques such as modularity measurement (e.g., the Louvain method) to classify nodes into different clusters in the IBD network. Each cluster may represent a community. The community assignment engine 230 may also determine sub-clusters, which represent sub-communities. The computing server 130 saves the data representing the IBD network and clusters in the IBD network data store 235. U.S. Pat. No. 10,223,498, entitled “Discovering Population Structure from Patterns of Identity-By-Descent,” granted on Mar. 5, 2019, describes example embodiments of community detection and assignment.

The community assignment engine 230 may also assign communities using supervised techniques. For example, inheritance datasets of known genetic communities (e.g., individuals with confirmed ethnic origins) may be used as training sets that have labels of the genetic communities. Supervised machine learning classifiers, such as logistic regressions, support vector machines, random forest classifiers, and neural networks may be trained using the training set with labels. A trained classifier may distinguish binary or multiple classes. For example, a binary classifier may be trained for each community of interest to determine whether a target individual's inheritance dataset belongs or does not belong to the community of interest. A multi-class classifier such as a neural network may also be trained to determine whether the target individual's inheritance dataset most likely belongs to one of several possible genetic communities.

Reference panel sample store 240 stores reference panel samples for different genetic communities. A reference panel sample is the genetic data of an individual whose genetic data is the most representative of a genetic community. The genetic data of individuals with the typical alleles of a genetic community may serve as reference panel samples. For example, some alleles of genes may be over-represented (e.g., being highly common) in a genetic community. Some inheritance datasets include alleles that are commonly present among members of the community. Reference panel samples may be used to train various machine learning models in classifying whether a target inheritance dataset belongs to a community, determining the ethnic composition of an individual, and determining the accuracy of any genetic data analysis, such as by computing a posterior probability of a classification result from a classifier.

A reference panel sample may be identified in different ways. In some embodiments, an unsupervised approach in community detection may apply the clustering algorithm recursively for each identified cluster until the sub-clusters contain a number of nodes that are smaller than a threshold (e.g., containing fewer than 1000 nodes). For example, the community assignment engine 230 may construct a full IBD network that includes a set of individuals represented by nodes and generate communities using clustering techniques. The community assignment engine 230 may randomly sample a subset of nodes to generate a sampled IBD network. The community assignment engine 230 may recursively apply clustering techniques to generate communities in the sampled IBD network. The sampling and clustering may be repeated for different randomly generated IBD networks for various runs. Nodes that are consistently assigned to the same genetic community when sampled in various runs may be classified as a reference panel sample. The community assignment engine 230 may measure the consistency in terms of a predetermined threshold. For example, if a node is classified to the same community 95% (or another suitable threshold) of the times the node is sampled, the inheritance dataset corresponding to the individual represented by the node may be regarded as a reference panel sample. Additionally, or alternatively, the community assignment engine 230 may select N most consistently assigned nodes as a reference panel for the community.

Other ways to generate reference panel samples are also possible. For example, the computing server 130 may collect a set of samples and gradually filter and refine the samples until high-quality reference panel samples are selected. For example, a candidate reference panel sample may be selected from an individual whose recent ancestors were born at a certain birthplace. The computing server 130 may also draw sequence data from the Human Genome Diversity Project (HGDP). Various candidates may be manually screened based on their family trees, relatives' birth location, and other quality controls. Principal component analysis may be used to create clusters of genetic data of the candidates. Each cluster may represent an ethnicity. The predictions of the ethnicity of those candidates may be compared to the ethnicity information provided by the candidates to perform further screening.

The ethnicity estimation engine 245 estimates the ethnicity composition of an inheritance dataset of a target individual. The inheritance datasets used by the ethnicity estimation engine 245 may be genotype datasets or haplotype datasets. For example, the ethnicity estimation engine 245 estimates the ancestral origins (e.g., ethnicity) based on the individual's genotypes or haplotypes at the SNP sites. To take a simple example of three ancestral populations corresponding to African, European and Native American, an admixed user may have nonzero estimated ethnicity proportions for all three ancestral populations, with an estimate such as [0.05, 0.65, 0.30], indicating that the user's genome is 5% attributable to African ancestry, 65% attributable to European ancestry and 30% attributable to Native American ancestry. The ethnicity estimation engine 245 generates the ethnic composition estimate and stores the estimated ethnicities in a data store of computing server 130 with a pointer in association with a particular user.

In some embodiments, the ethnicity estimation engine 245 divides a target inheritance dataset into a plurality of windows (e.g., about 1000 windows). Each window includes a small number of SNPs (e.g., 300 SNPs). The ethnicity estimation engine 245 may use a directed acyclic graph model to determine the ethnic composition of the target inheritance dataset. The directed acyclic graph may represent a trellis of an inter-window hidden Markov model (HMM). The graph includes a sequence of a plurality of node groups. Each node group, representing a window, includes a plurality of nodes. The nodes represent different possibilities of labels of genetic communities (e.g., ethnicities) for the window. A node may be labeled with one or more ethnic labels. For example, a level includes a first node with a first label representing the likelihood that the window of SNP sites belongs to a first ethnicity and a second node with a second label representing the likelihood that the window of SNPs belongs to a second ethnicity. Each level includes multiple nodes so that there are many possible paths to traverse the directed acyclic graph.

The nodes and edges in the directed acyclic graph may be associated with different emission probabilities and transition probabilities. An emission probability associated with a node represents the likelihood that the window belongs to the ethnicity labeling the node given the observation of SNPs in the window. The ethnicity estimation engine 245 determines the emission probabilities by comparing SNPs in the window corresponding to the target inheritance dataset to corresponding SNPs in the windows in various reference panel samples of different genetic communities stored in the reference panel sample store 240. The transition probability between two nodes represents the likelihood of transition from one node to another across two levels. The ethnicity estimation engine 245 determines a statistically likely path, such as the most probable path or a probable path that is at least more likely than 95% of other possible paths, based on the transition probabilities and the emission probabilities. A suitable dynamic programming algorithm such as the Viterbi algorithm or the forward-backward algorithm may be used to determine the path. After the path is determined, the ethnicity estimation engine 245 determines the ethnic composition of the target inheritance dataset by determining the label compositions of the nodes that are included in the determined path. U.S. Pat. No. 10,558,930, entitled “Local Genetic Ethnicity Determination System,” granted on Feb. 11, 2020, and U.S. Pat. No. 10,692,587, granted on Jun. 23, 2020, entitled “Global Ancestry Determination System” describe different example embodiments of ethnicity estimation.

The tree management engine 250 performs computations and other processes related to users' management of their data trees such as family trees. The tree management engine 250 may allow a user to build a data tree from scratch or to link the user to existing data trees. In some embodiments, the tree management engine 250 may suggest a connection between a target individual and a family tree that exists in the family tree database by identifying potential family trees for the target individual and identifying one or more most probable positions in a potential family tree. A user (target individual) may wish to identify family trees to which he or she may potentially belong. Linking a user to a family tree or building a family may be performed automatically, manually, or using techniques with a combination of both. In an embodiment of an automatic tree matching, the tree management engine 250 may receive an inheritance dataset from the target individual as input and search related individuals that are IBD-related to the target individual. The tree management engine 250 may identify common ancestors. Each common ancestor may be common to the target individual and one of the related individuals. The tree management engine 250 may in turn output potential family trees to which the target individual may belong by retrieving family trees that include a common ancestor and an individual who is IBD-related to the target individual. The tree management engine 250 may further identify one or more probable positions in one of the potential family trees based on information associated with matched genetic data between the target individual and those in the potential family trees through one or more machine learning models or other heuristic algorithms. For example, the tree management engine 250 may try putting the target individual in various possible locations in the family tree and determine the highest probability position(s) based on the inheritance dataset of the target individual and inheritance datasets available for others in the family tree and based on genealogy data available to the tree management engine 250. The tree management engine 250 may provide one or more family trees from which the target individual may select. For a suggested family tree, the tree management engine 250 may also provide information on how the target individual is related to other individuals in the tree. In a manual tree building, a user may browse through public family trees and public individual entries in the genealogy data store 200 and individual profile store 210 to look for potential relatives that can be added to the user's family tree. The tree management engine 250 may automatically search, rank, and suggest individuals for the user conduct manual reviews as the user makes progress in the front-end interface 260 in building the family tree.

As used herein, “pedigree” and “family tree” may be interchangeable and may refer to a family tree chart or pedigree chart that shows, diagrammatically, family information, such as family history information, including parentage, offspring, spouses, siblings, or otherwise for any suitable number of generations and/or people, and/or data pertaining to persons represented in the chart. U.S. Pat. No. 11,429,615, entitled “Linking Individual Datasets to a Database,” granted on Aug. 30, 2022, describes example embodiments of how an individual may be linked to existing family trees.

The front-end interface 260 may render a front-end platform that displays various results determined by the computing server 130. The platform may take the form of a genealogy research and family tree building platform and/or a personal DNA data analysis platform. The platform may also serve as a social networking system that allows users and connect and build family trees and research family relations together. The results and data may include the IBD affinity between a user and another individual, the community assignment of the user, the ethnicity estimation of the user, phenotype prediction and evaluation, genealogy data search, family tree and pedigree, relative profile and other information. The front-end interface 260 may allow users to manage their profile and data trees (e.g., family trees). The users may view various public family trees stored in the computing server 130 and search for individuals and their genealogy data via the front-end interface 260. The computing server 130 may suggest or allow the user to manually review and select potentially related individuals (e.g., relatives, ancestors, close family members) to add to the user's data tree. The front-end interface 260 may be a graphical user interface (GUI) that displays various information and graphical elements.

The front-end interface 260 may take different forms. In one case, the front-end interface 260 may be a software application that can be displayed on an electronic device such as a computer or a smartphone. The software application may be developed by the entity controlling the computing server 130 and be downloaded and installed on the client device 110. In another case, the front-end interface 260 may take the form of a webpage interface of the computing server 130 that allows users to access their family tree and genetic analysis results through web browsers. In yet another case, the front-end interface 260 may provide an application program interface (API). In some embodiments, the front-end interface 260 may be rendered as part of the content in an extended reality device, such as a head-mounted display or a phone camera that is integrated with augmented reality features.

The front-end interface 260 may provide various front-end visualization features. In some embodiments, a family tree viewer may render family tree built by users and/or managed by the tree management engine 250. The family tree may be displayed in a nested nodes and edges connected based on family relationships or genetic matches determined by various genetic data analysis engines discussed in FIG. 2. The family trees may include attached records that are part of records in the genealogy data store 200, including records that are uploaded by users and gallery images. The user may assign a focal person to a family tree and the family tree is displayed with the focus (such as positioning the focal person at the center or relative prominent position of the tree) around the focal person. A user may change the focal person and the family tree may shift accordingly based on the relationships and relative positions of members in the family tree. Each person in the family tree may be associated with historical photos from gallery images, historical genealogy records such as life event records, one or more stories and live events associated with the person, and metadata such as family relationships and other family trees associated with the person.

In some embodiments, visualization features provided by the front-end interface 260 may include a map feature. A map may be a geographical map that may take the form of a digital map, a historical physical map, and/or a historical map overlaid on a digital map. A user may select a geographical location and the front-end interface 260 displays relevant genealogical or genetic records associated with the location, such as an ancestor's lifetime events, birth locations of DNA matches, mitigation patterns of ancestors across different locations over time and associated genealogical records, residence maps that provide specific locations of historical persons' events, and historical maps overlaying on a digital map to contextualize ancestors' records and events. The map feature may also provide interactive features to allow users to view historical documents, photographs, and stores associated with the geographical locations. The map feature may also allow users to adjust timeframes, displaying changes in locations and migrations over different periods.

In some embodiments, visualization features provided by the front-end interface 260 may include a story feature that provides multimedia narratives about a person, such as the person's live events and family history. The story feature allows a user to compile various graphical and genealogical elements such as photos, documents, historical records, and personal anecdotes into a timeline to summarize a narrative. The story may be arranged in an appropriate spatial manner such as a linear arrangement that arranges various graphical elements based on the creator's selection.

In this disclosure, a genetic data may be an example of inheritance data. An individual is an example of a named entity. A genetic sequence is an example of data string or bit string. A genetic segment is an example of data string segment. A matched genetic segment is an example of matched data string. For example, an IBD segment is an example of a matched data string segment. An ethnicity is an example or a data origin or a data classification. A phenotype, or a phenotypic trait, is an example of a data manifestation, and both “phenotype” and “phenotypic trait” are used interchangeably herein. A reproductive event is an example of a data inheritance event.

The record linking engine 265 may provide a multi-stage process for linking source and target records. The record linking engine 265 may use a first machine learning model to convert records into embeddings and compare them to identify potential matches. The record linking engine 265 may apply a second machine learning model to evaluate field similarities between the source record and a candidate record. The record linking engine 265 may use a third model that incorporates contextual data to assess the likelihood of a match because the source and candidate records. The record linking engine 265 may combine the outputs from the second and third models to determine the most likely link between the source and target records.

### Linking Records Using Multi-Stage Machine Learning Models and Contextual Data Analysis

In a large database of genealogy records, there can be many records that belong or correspond to the same person, but determining which record belong to the same person can be challenging due to data quality in historical records. It is surprising that a machine learning model, such as a sentence transformer, can be used to effectively convert a record (which typically is not a sentence, but a collection of information) into an embedding. In a source collection, a source record can be converted into a source embedding. In a target collection that might have a record that corresponds to the same person, the target records can be converted into target embeddings. Near neighbors can be identified as candidates. Embeddings may be used to identify candidate records for linking, but may not be used after the candidate identification. The candidate records (e.g., the candidate genealogical records) can then be used to compare to the source record(s). Context features (e.g., number of shared relatives, birth years, surname sound, mitigation data, etc.) may be extracted. The context features can be input into a machine learning model, such as a supervised classifier, to select the best candidate in the set. Because each collection should have only one record for a person (e.g., birth record collection has only one birth record per person), the best matched record can be selected.

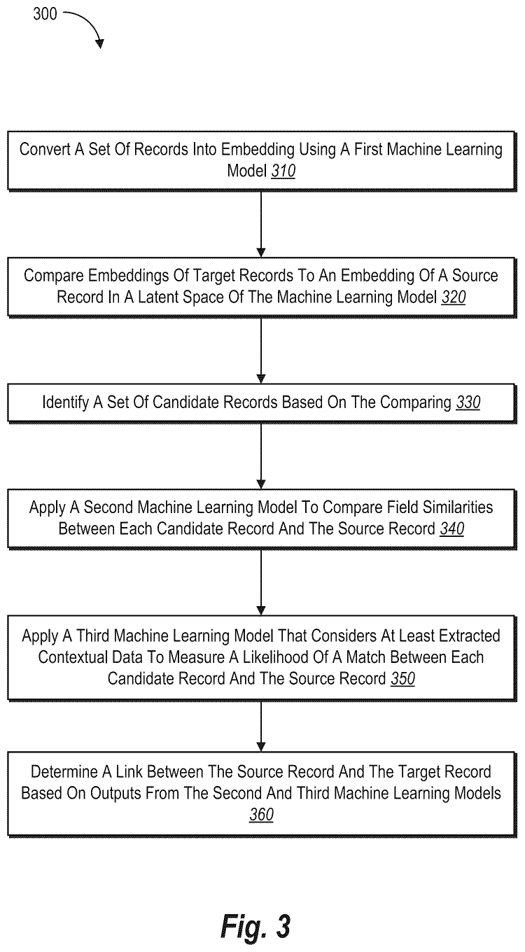

FIG. 3 is a flowchart depicting an example process 300 for the record-linking system 102 linking records using multi-stage machine learning models and contextual data analysis, in accordance with some embodiments. The process 300 may be performed by one or more engines of the computing server 130 illustrated in FIG. 2, such as the record linking engine 265. The process 300 may be embodied as a software algorithm that may be stored as computer instructions that are executable by one or more processors. The instructions, when executed by the processors, cause the processors to perform various steps in the process 300. In various embodiments, the process 300 may include additional, fewer, or different steps. While various steps in the process 300 may be discussed with the use of computing server 130, each step may be performed by a different computing device.

In some embodiments, the computing server 130 can convert a set of records into embeddings using a first machine learning model (step 310). The computing server 130 can convert the set of records into the embeddings by generating input strings for each record and inputting the generated input strings into the first machine learning model (e.g., a sentence transformer). The first machine learning model can generate embedding for each record. The embedding can be configured such that the records corresponding to a same entity have embedding values close to each other in the latent space of the machine learning model.

In some embodiments, the computing server 130 can compare embeddings of target records to an embedding of a source a source record in a latent space of the machine learning model (step 320). For example, the computing server 130 can perform a search to identify the embeddings of the target records that are closest to the embedding of the source record in the latent space.

In some embodiments, the computing server 130 can identify a set of candidate records based on the comparing (step 330). The computing server 130 may identify the set of candidate records by selecting, as the set of candidate records, a predetermined number of target records whose embeddings are nearest to the embedding of the source record in the latent space.

In some embodiments, the computing server 130 can apply a second machine learning model to compare field similarities between each candidate record and the source record (step 340). The computing server 130 may apply the second machine learning model by extracting field data from the candidate record and the source record. The field data can include any one of: name information, family member information, birth year information, birth place information, or occupation information. The computing server 130 may input the extracted field data into the second machine learning model. The second machine learning model may compare the field data of the candidate record with the field data of the source record to generate a prediction indicating whether the candidate record and the source record correspond to the same entity or to different entities.

In some embodiments, the computing server 130 can apply a third machine learning model that considers at least extracted contextual data to measure a likelihood of a match between each candidate record and the source record (step 350). The computing server 130 may extract contextual data related to the candidate record and the source record. The extracted contextual data may include any one of: a source score difference; a household link indicator; a birth year difference; a state match indicator; a household given name match count; a source candidate count; a surname phonetic similarity score; a surname string similarity score; a migration score; a given name string similarity score; a target candidate count; a given name phonetic similarity score; a county match indicator; or a city match indicator. The computing server 130 may combine the extracted contextual data with the output of the second machine learning model, and input the combined data into the third machine learning model. The third machine learning model may generate a match likelihood score indicating a probability measure that the candidate record and the source record correspond to the same entity.

The source score difference may be the difference between the current candidate's score and the highest score among all candidates for this source record. The household link indicator may indicate whether there is an existing link between other members of the households in the source and candidate records. The birth year difference may be the difference between the birth years recorded in the source and candidate records. The state match indicator may indicate whether the states mentioned in the source and candidate records match. The household given name match count may be the number of matching given names between the households in the source and candidate records. The source candidate count may be the total number of candidates identified for the current source record. The surname phonetic similarity score may be a measure of how phonetically similar the surnames in the source and candidate records are. This measure may be based on a phonetic algorithm.

The surname string similarity score may be a measure of how similar the surname strings are in the source and candidate records. This score may be determined by using a string comparison metric. The migration score may be a measure of the likelihood of migration between the locations mentioned in the source and candidate records. The migration score may be based on historical migration patterns. The given name string similarity score may be a measure of how similar the given name strings are in the source and candidate records. The target candidate count may be the number of times the target record appears as a candidate for different source records. The given name phonetic similarity score may be a measure of how phonetically similar the given names in the source and candidate records are. This score may be determined by using a phonetic algorithm. The county match indicator may be a binary indicator showing whether the counties mentioned in the source and candidate records match. The city match indicator may be a binary indicator showing whether the cities mentioned in the source and candidate records match.

In some embodiments, the computing server 130 can determine a link between the source record and the target record based on outputs from the second and third machine learning models (step 360). The computing server 130 may combine the prediction from the second machine learning model and the match likelihood score from the third machine learning model to generate a composite score for each candidate record. The computing server 130 may rank the candidate records based on their respective composite scores. The computing server 130 may select the candidate record with the highest ranking. The computing server 130 may compare the composite score of the selected candidate record to a predetermined threshold. Responsive to the composite score exceeding the predetermined threshold, the computing server 130 may link on a database the source record and the selected candidate record. The computing server 130 may perform a deduplication process to prevent the source record from being linked to multiple candidate records. To perform the deduplication process, the computing server 130 may identify a set of linked candidate records that have been linked to the source record based on their composite score exceeding the predetermined threshold. The computing server 130 may compare the composite scores of the linked candidate records. The computing server 130 may select the linked candidate record with the highest score. The computing server 130 may update the database to maintain the link between the source record and the selected linked candidate record, and remove the links between the source record and non-selected linked candidate records.

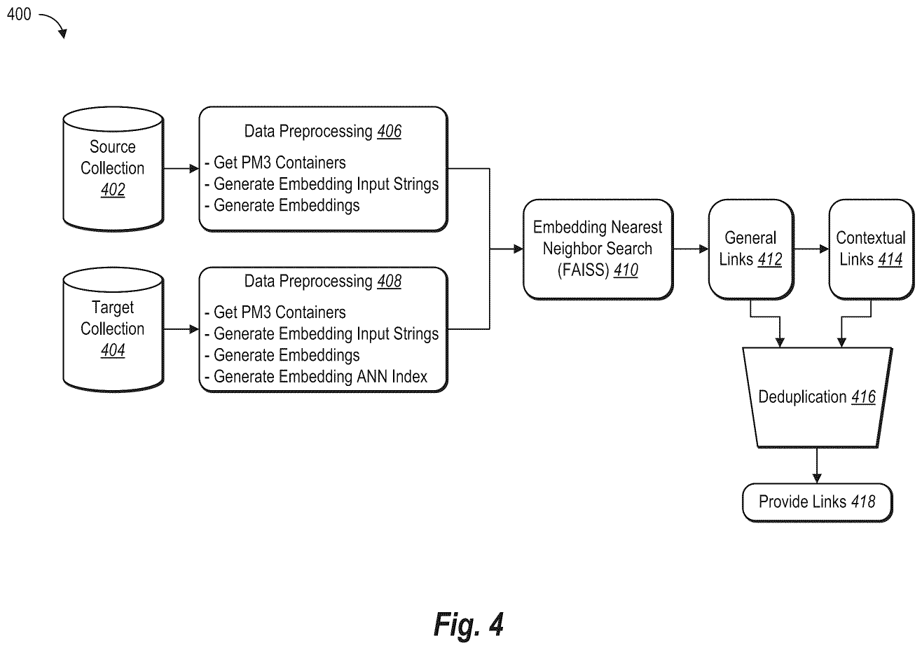

FIG. 4 illustrates a record linking process 400 that the record-linking system 102 performs according to one or more embodiments. The source collection database 402 and target collection database 404 may contain the records to be linked. Data preprocessing blocks 406 and 408 may generate embeddings for the source and target records respectively, using a first machine learning model to convert record information into a embeddings.

The data preprocessing block 406 may perform several steps to prepare the source record for the linking process. The data preprocessing block 406 may retrieve the PM3 containers, which are JSON storage containers used to store record information in a structured format. These containers may hold all the relevant data for each record, including names, dates, locations, and other genealogical information. The data preprocessing block 406 may generate embedding input strings from the PM3 container data. The data preprocessing block 406 may generate embeddings by inputting the strings into the first machine learning model. The first machine learning model may be a sentence transformer. The first machine learning model may create a vector representation (embedding) of the source record in a high-dimensional space, where records belonging to the same entity are positioned close to each other.

The data preprocessing block 408 for the target records may retrieve the PM3 containers for all target records, accessing the structured JSON data that contains comprehensive genealogical information. The data preprocessing block 408 may generate embedding input strings from these PM3 containers, converting the structured data into a format optimized for the embedding model. The data preprocessing block 408 may then generate embeddings by feeding these input strings into the first machine learning model to generate vector representations of each target record. A step, unique to the target record processing, is the generation of an embedding ANN (approximate nearest neighbor) index (which achieves approximately 90% of the performance of brute force nearest neighbor search at 10% of the computational cost). This index may provide for efficient similarity search in large datasets. It may organize the target record embeddings in a way that allows for rapid identification of the most similar records without the need for exhaustive comparison. This ANN index may speed up the nearest neighbor search process, providing a comparison of the source record against a large number of potential matches in the target collection efficiently.

The record linking process 400 of FIG. 4 further includes components performed by the two-stage framework mentioned above. For instance, the first stage can include an embedding nearest neighbor search block 410 that involves using a machine learning model (e.g., a deep learning model such as SBERT) fine tuned to extract and compare record embeddings to identify candidate records for further analysis at the second stage. Indeed, the second stage of the ensemble framework can include a general link block 412 and a contextual link block 414 that are each executed using respective machine learning models trained on respective datasets to generate scores informing a link prediction.

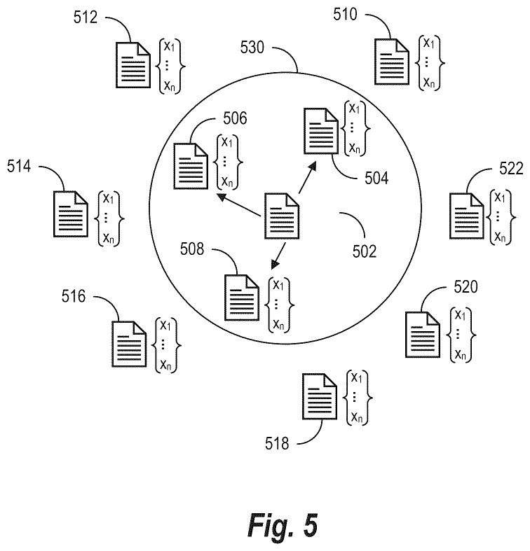

As shown, the embedding nearest neighbor search block 410 then compares these embeddings in a latent space, selecting a predetermined number of target records closest to the source record as candidate matches. FIG. 5 illustrates the concept of the record-linking system 102 performing embedding-based candidate selection in the latent space created by the first machine learning model (e.g., the fine-tuned candidate retrieval model). FIG. 5 shows multiple embeddings (504, 506, 508, 510, 512, 514, 516, 518, 520 and 522) representing various target records from the target collection, and a single embedding (502) representing the source record. Each embedding is a point in a high-dimensional space, but for visualization purposes, it is represented in a 2D plane. The embeddings 504, 506, and 508 are positioned closest to the source record embedding 502 in the latent space (e.g., the record-linking system 102 determines that the embeddings 504, 506, and 508 are within a threshold distance 530 of the source record embedding 502). This proximity indicates that these target records are most similar to the source record in terms of the features captured by the embedding model. The process of candidate selection may include identifying these nearest neighbors. The embedding nearest neighbor search block 410 may perform this selection. In some embodiments, the embedding nearest neighbor search block 410 may uses the ANN index created for the target collection to efficiently identify a predetermined number of closest embeddings (in this case, embeddings 504, 506, and 508). The corresponding target records may be selected as the set of candidate records for further analysis.

Referring back to FIG. 4, for each candidate record from the set of target records, the general link block 412 (e.g., the second machine learning model in the form of a general-link-predictor model) may apply a second machine learning model to compare field similarities between the candidate record and the source record, focusing on specific attributes such as names, dates, and locations. For each candidate record, the contextual link block 414 (e.g., the third machine learning model in the form of a contextual-link-predictor model) may use a third machine learning model that considers extracted contextual data along with the output from block 412, to measure the likelihood of a match between the candidate record and the source record.

The deduplication block 416 may combine the outputs from blocks 412 and 414 to determine the best link while verifying that the source record isn't matched to multiple candidates. The deduplication block 416 may rank candidate records, applying thresholds, and update a database of links to maintain only the most probable link. The block 418 may provide the established link between the source record and the selected target record as an output of the multi-stage linking process 400.

As used herein, the term “machine learning model” can refer to a computer algorithm or a collection of computer algorithms that automatically improve for a particular task through iterative outputs or predictions based on use of data. For example, a machine learning model can utilize one or more learning techniques to improve in accuracy and/or effectiveness. Example machine learning models include various types of neural networks, decision trees, support vector machines, and Bayesian networks. In some embodiments, the record-linking system 102 utilizes machine learning model in the form of a neural network.

Relatedly, as used herein, the term “neural network” refers to a machine learning model that can be trained and/or tuned based on inputs to determine classifications, scores, or approximate unknown functions. For example, a neural network includes a model of interconnected artificial neurons (e.g., organized in layers) that communicate and learn to approximate complex functions and generate outputs (e.g., responses, data for passing to downstream models, and/or records) based on a plurality of inputs provided to the neural network. In some cases, a neural network refers to an algorithm (or set of algorithms) that implements deep learning techniques to model high-level abstractions in data. A neural network can include various layers such as an input layer, one or more hidden layers, and an output layer that each perform tasks for processing data. For example, a neural network can include a deep neural network, a convolutional neural network, a recurrent neural network (e.g., an LSTM), a graph neural network, a transformer neural network, or a generative adversarial neural network.

As used herein, the term “genealogical record” (or sometimes simply “record”) can refer to a digital object or a digital file that includes information (e.g., genealogical information) interpretable by a computing device (e.g., a client device) to present information to a user. A record can include a file such as a digital text file, a digital image file, a digital audio file, a webpage, a website, a digital video file, a web file, a link, a digital document file, or some other type of file or digital object. A record can have a particular file type or file format, which may differ for different types of digital records (e.g., digital documents, digital images, digital videos, or digital audio files). In some cases, a record can refer to a genealogical record that includes or depicts historical or genealogical information, such as a birth certificate, a digitized newspaper article, a digitized photograph of a relative, a digitized census record, a digitized obituary, a digitized court document, a digitized DNA analysis, or a digitized family tree. In some embodiments, a genealogical record includes a record selected or identified to surface to a client device, such as an item in a response, a record hint (e.g., a stored or generated genealogical record surfaced as a suggestion for a user account), a digital story (e.g., a stored collection of genealogical records arranged for a particular person, topic, or entity of a genealogical-data system), a digital image (e.g., a digitized photograph), a new person hint (e.g., a suggested node to add to a genealogical tree), a member tree hint (e.g., a prediction for correcting a node within a genealogical tree of a user account), or a DNA match (e.g., a record indicating a DNA match of a user account to a relative whose information is stored in a genealogical-data system).

Additionally, in some embodiments genealogical records can be separated into collections. Further, the separate collections can be stored or otherwise hosted on separate databases. To provide an example, the record-linking system 102 can use a first database to store a first type of genealogical records, such as census records, a second database to store a second type of genealogical records, such as birth-marriage-death (BMD) records, a third database to store a third type of genealogical records, such as immigration records, a fourth database to store a fourth type of genealogical records, such as user-account generated content (e.g., journals, photos, videos, etc.), among others. The record-linking system can analyze and stitch various genealogical records to create a traceable backbone. The record-linking system 102 can expand the traceable backbone by generating links between candidate genealogical records and source genealogical records.

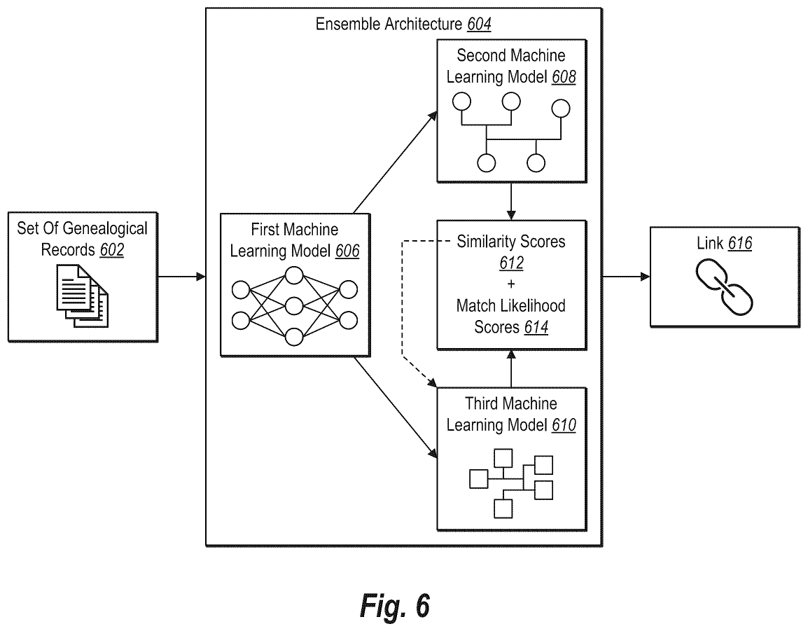

As previously mentioned, the record-linking system 102 can generate a link from a set of genealogical records. For example, the record-linking system 102 can use a first machine learning model, a second machine learning model, and a third machine learning model to generate a link from a set of genealogical records. Indeed, as outlined above, the record-linking system 102 utilizes an ensemble framework that includes: 1) a first-stage model that extracts and compares record embeddings to select candidate records and 2) two second-stage models, one that generates link scores on a general (e.g., database-wide or collection-wide) level and another that generates link scores on a contextual level (considering additional features that inform the score) in the context of other existing links or potential candidates. FIG. 6 illustrates the record-linking system 102 utilizing an ensemble architecture that includes a first machine learning model, a second machine learning model, and a third machine learning model to generate a link from a set of genealogical records in accordance with one or more embodiments.

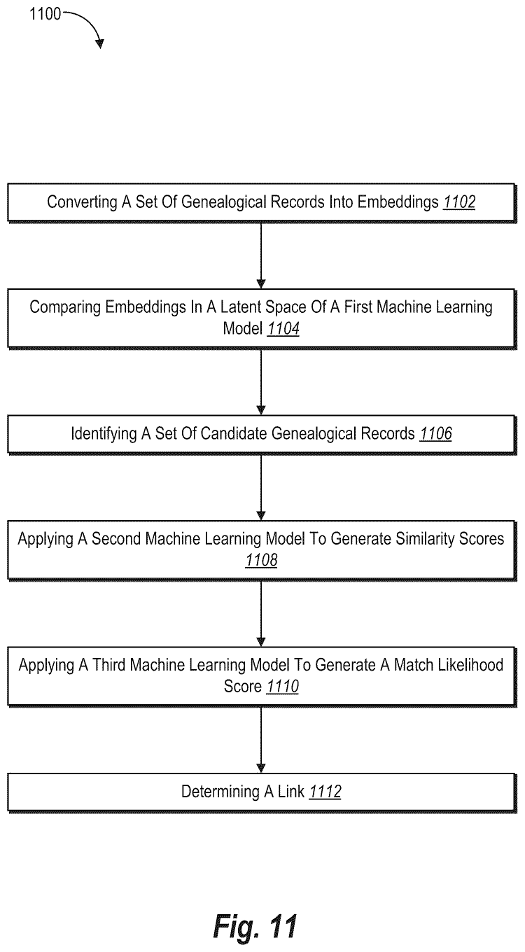

As shown in FIG. 6, the record-linking system 102 can provide a set of genealogical records 602 to an ensemble architecture 604. The set of genealogical records 602 can include one or more target genealogical records and one or more source genealogical records. As used herein, the term “source genealogical record” can refer to a genealogical record within a genealogical-data system (e.g., the genealogical-data system 1302 of FIG. 11) used as a source or subject for determining a record link to one or more additional records. A source genealogical record can be a genealogical record within the genealogy data store 200 of FIG. 2. Relatedly, as used herein, the term “target genealogical record” can refer to a genealogical record within the genealogical-data system that is not linked or otherwise connected to a traceable backbone, e.g., such as a genealogical database. For example, a target genealogical record can be a record that the record-linking system 102 identifies and integrates within the genealogical-data system.

As shown in FIG. 6, the record-linking system 102 can use the first machine learning model 606 to analyze the set of genealogical records 602 (e.g., records within a particular collection or database, such as census records). To illustrate, the record-linking system 102 can use the first machine learning model 606 (e.g., in the form of a fine-tuned candidate retrieval model as described for the embedding nearest neighbor search block 410) to generate embeddings of the set of genealogical records 602. Specifically, the record-linking system 102 can use the first machine learning model 606 to generate embeddings of one or more target genealogical records and an embedding of a source genealogical record.

Further, as discussed above with regard to FIG. 5, the record-linking system 102 can compare the embeddings of the target genealogical records to the embedding of the source genealogical record within a latent space of the first machine learning model. The record-linking system 102 can compare the embeddings of the target genealogical records to the embedding of the source genealogical record to identify a set of candidate embeddings of target genealogical records that are within a threshold distance of the source genealogical records (e.g., embeddings that correspond to candidate records), e.g., using a k-nearest neighbors approach. The record-linking system 102 can determine a distance (to compare with a threshold distance) between embeddings by determining a cosine distance, a Euclidean distance, or some other distance in embedding space. In some embodiments, the threshold distance can be a proximity threshold that indicates embeddings within the proximity threshold correspond to a same individual.

In some embodiments the record-linking system 102 can use the first machine learning model 606 to generate the embeddings from the set of genealogical records 602 in parallel, thus reducing overhead required to generate the embeddings and increasing computational efficiency compared to sequential systems that process each record iteratively. Further, the record-linking system 102 can parallelly compare the embeddings of the target genealogical records to the embedding of the source genealogical record to identify embeddings that correspond to the records to select as candidates (which can further reduce overhead and increase computational efficiency compared to iterative systems).

Based on identifying the candidate records, the record-linking system 102 can extract field data from the candidate records corresponding to the embeddings. For example, the record-linking system 102 can analyze a first candidate embedding of the candidate embeddings to extract field data from the genealogical record corresponding to the first candidate embedding. The field data can include types of personal information corresponding to an individual of the genealogical record, such as name information (e.g., a given name and a surname), family member information, birth year information, birthplace information (e.g., geographical location of a birthplace), and occupation information, among others.

Based on extracting field data for each embedding of the candidate embeddings, the record-linking system 102 can input the field data into a second machine learning model 608 (e.g., in the form of a general-link predictor as described for general link block 412). The record-linking system 102 can apply the second machine learning model 608 to generate similarity scores 612 between each set of field data for the candidate records (or candidate embeddings) and a set of field data for the embedding of the source genealogical record. For example, the record-linking system 102 can generate a similarity scores to indicate how likely two records correspond to the same entity (e.g., person, place, or event). The record-linking system 102 can thus generate the similarity scores 612 for each candidate record in relation to the source record.

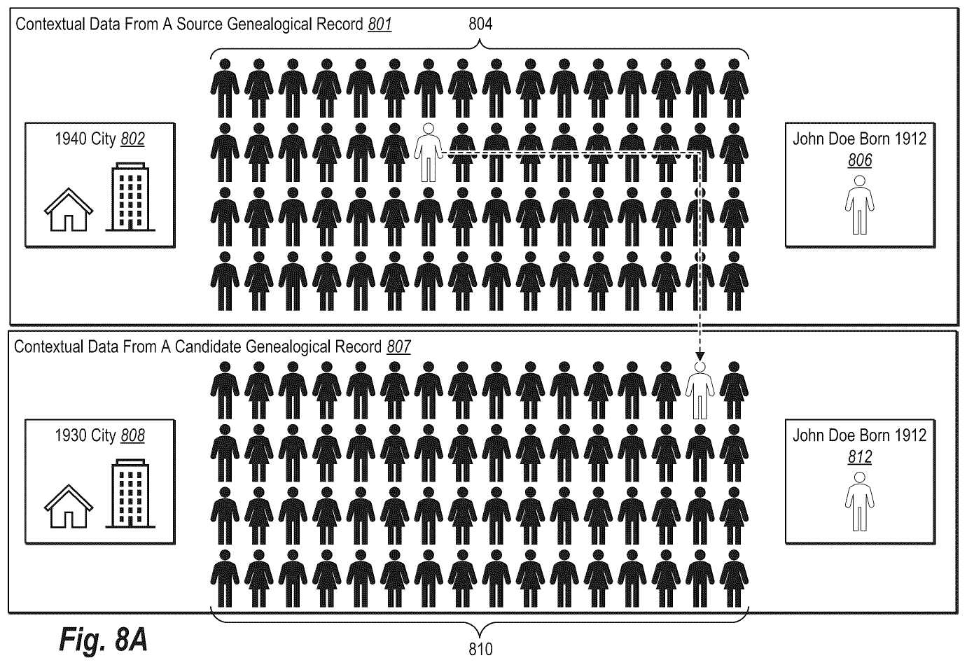

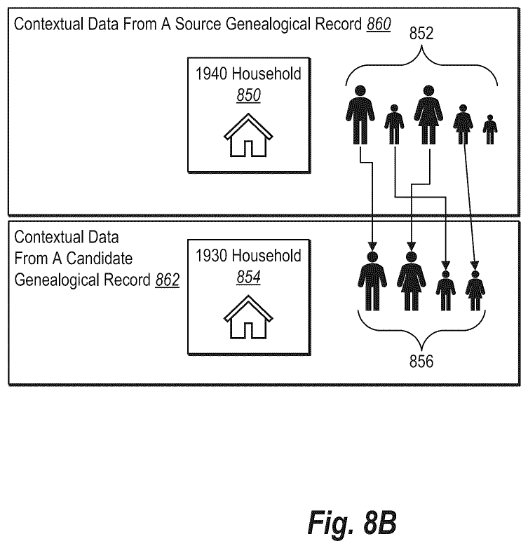

Additionally, the record-linking system 102 can extract contextual data or contextual features associated with each candidate record. More information regarding extracting contextual data can be found below with regard to the discussion of FIGS. 8A and 8B. Based on extracting the contextual data, the record-linking system 102 can apply a third machine learning model 610 (e.g., in the form of a contextual-link-predictor model as described for the contextual link block 414) to process the contextual data associated with each candidate record. Specifically, the record-linking system 102 can use the third machine learning model 610 to generate match likelihood scores 614 for the candidate records. As used herein, the term “match likelihood score” can refer to a context-based score that indicates a likelihood of a match between a candidate record and a source genealogical record according to contextual data (e.g., between the source genealogical record and the candidate record) indicating existing record links and/or potential links.

In some embodiments, the record-linking system 102 trains the second machine learning model 608 and the third machine learning model 610 from a particular base model, such as a multi-qa-MiniLM-L6-co-v1 model (a type of language model in the form of a sentence transformer). To elaborate, the record-linking system 102 can train the second machine learning model 608 to generate link predictions (e.g., predicting the similarity scores 612) using approximately 1.3M record pairs from varying collections or databases, in addition to related names data and related place data, using a multiple-negatives-ranking loss function (approximately 9 hours of training time). The different sources for training the second machine learning model 608 can include BMD records, census records, immigration records, and military records. Additionally, the record-linking system 102 can train the third machine learning model 610 from the same base model with the same loss function over approximately 4.5M pairs of census records from 1850 to 1950, with some data augmentations for varying the representation or format of the records (approximately 32 hours of training time).

In one or more embodiments, the record-linking system 102 performs data augmentation or manipulation to modify training data for the third machine learning model 610 to generalize its ability to predict match likelihood scores among records beyond census records (e.g., to stitch additional records to census backbone). For example, the record-linking system 102 creates four types, labels, or string representations of training data from available census records: “normal,” “random,” “prose,” and “sparse.” The record-linking system 102 generates normal to include a field name and a corresponding value for the field. The record-linking system 102 generates random data to include data fields in a random order. In addition, the record-linking system 102 generates prose data by rephrasing a record to generate a more readable, natural language version of data fields. Further, the record-linking system 102 generates sparse data by synthetically nullifying one or more data fields. In one or more embodiments, the record-linking system 102 divides training data into respective proportions of these training data types: 40% normal, 20% random, 20% prose, and 20% sparse. In some cases, the third machine learning model 610 can be an XGBoost binary classifier.

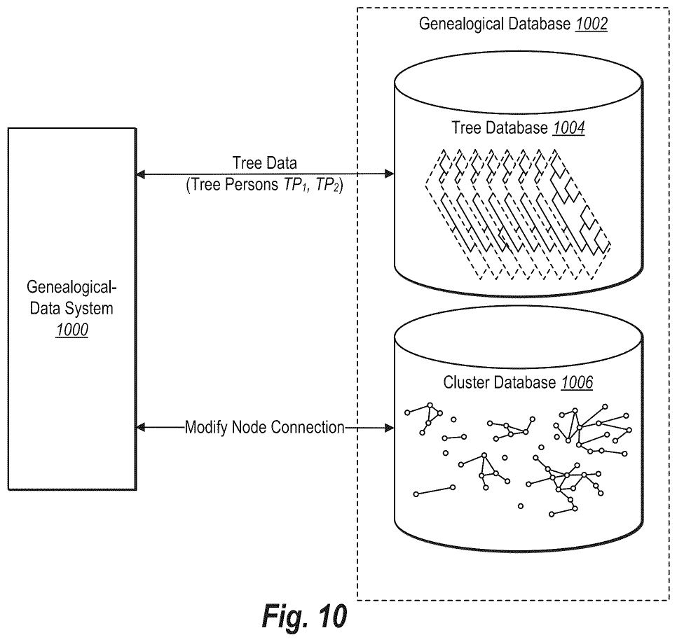

As shown in FIG. 6, the record-linking system 102 can combine the similarity scores 612 and the match likelihood scores 614 to generate a link 616 between the source genealogical record and a target genealogical record. As used herein, the term “link” can refer to a connection or integration of a target genealogical record (and/or a collection of target genealogical records) to another genealogical record. For example, a link can associate a target record with an existing backbone of genealogical records (e.g., a census backbone). In some embodiments, the existing backbone of genealogical records can be a genealogical database (e.g., a genealogical database 1002 as discussed below with regard to FIG. 10).

As shown in FIG. 6, the record-linking system 102 can combine the similarity scores 612 and the match likelihood scores 614 corresponding to each candidate record to determine a composite score for each candidate genealogical record. The record-linking system 102 can determine the link 616 according to the composite scores. Further, in some embodiments, the record-linking system 102 can use the second machine learning model 608 to determine each of the similarity scores 612 for the candidate genealogical records in parallel (e.g., simultaneously) with one another. Additionally, the record-linking system 102 can use the third machine learning model 610 to determine each of the match likelihood scores 614 in parallel with one another.

Moreover, as shown in FIG. 6, the record-linking system 102 can use the second machine learning model 608 and the third machine learning model 610 in series (e.g., where the match likelihood scores 614 are based on the similarity scores 612) or in parallel (e.g., where the match likelihood scores 614 and the similarity scores 612 are independent of one another). For example, the record-linking system 102 can apply the second machine learning model 608 to generate the similarity scores 612 contemporaneously with applying the third machine learning model 610 to generate the match likelihood scores 614.

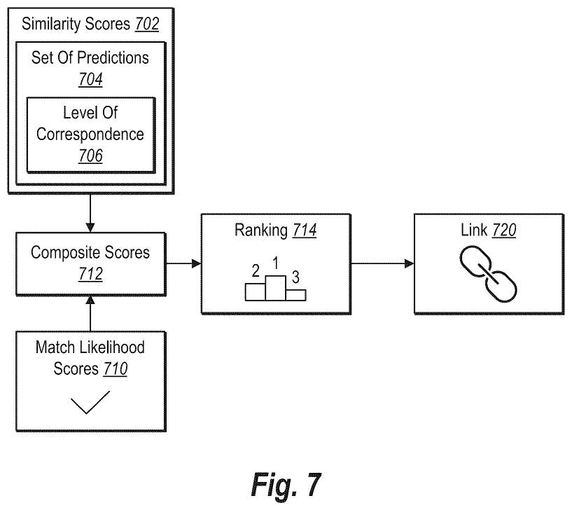

As previously mentioned, in some embodiments the record-linking system 102 can identify a candidate genealogical record. Indeed, the record-linking system 102 can identify a candidate record using a first machine learning model for candidate retrieval in the first phase of the two-phase ensemble framework (e.g., the ensemble architecture 604). FIG. 7 illustrates the record-linking system 102 identifying a candidate genealogical record according to a ranking of composite scores and linking the candidate genealogical record to a source collection responsive to determining that the candidate genealogical record meets or exceeds a predetermined threshold in accordance with one or more embodiments.

As shown in FIG. 7 and as previously discussed above with regard to FIG. 6, the record-linking system 102 can use a second machine learning model to generate similarity scores 702 between source genealogical records and candidate genealogical records. In some embodiments, the record-linking system 102 can generate the similarity scores 702 by generating a set of predictions 704 that indicate a level of correspondence 706 between each candidate genealogical record and the source genealogical records. Indeed, in some embodiments, the record-linking system 102 can determine the set of predictions 704 as a part of determining similarity scores between each candidate genealogical record and the source genealogical record. As used herein, the term “level of correspondence” can be a numerical quantification of a similarity between a candidate individual corresponding to a candidate genealogical record and a source individual corresponding to a source genealogical record. For example, the record-linking system 102 can base the level of correspondence on similarities between a first set of field data corresponding to the candidate genealogical record and a second set of field data corresponding to the source genealogical record. More information regarding the record-linking system 102 determining the level of correspondence between candidate genealogical records and source genealogical records can be found in U.S. Pat. No. 11,321,361, entitled “GENEALOGICAL ENTITY RESOLUTION SYSTEM AND METHOD,” filed on Oct. 24, 2017, which is incorporated by reference herein in its entirety.

As shown in FIG. 7, the record-linking system 102 can combine the set of predictions 704 with match likelihood scores 710 to generate composite scores 712 for the set of candidate genealogical records. The record-linking system 102 can use a third machine learning model (e.g., the third machine learning model 610 of FIG. 6) to generate the match likelihood scores. In some embodiments, the record-linking system 102 can select a first match likelihood score of the match likelihood scores 710 to combine with the set of predictions 704 to generate a first set of composite scores. Further, the record-linking system 102 can select a second match likelihood score of the match likelihood scores 710 to generate a second set of composite scores. Indeed, the record-linking system 102 can generate a set of composite scores for each match likelihood score of the match likelihood scores 710. In some embodiments, the record-linking system 102 can aggregate the sets of composite scores to generate the composite scores 712. In some embodiments, the record-linking system 102 can select the composite scores 712 from one or more sets of composite scores.

As shown in FIG. 7, the record-linking system 102 can use the composite scores 712 to determine a ranking 714 of the candidate genealogical records. For example, the record-linking system 102 can determine the ranking 714 of the candidate genealogical records based on their relative composite scores 712. For example, the record-linking system 102 can identify a relatively highest score of the composite scores 712 and assign a first candidate genealogical record that corresponds to the relatively highest score of the composite scores 712 a rank of first. Additionally, the record-linking system 102 can identify a second relatively highest score of the composite scores that is lower than the relatively highest score of the composite scores 712 but that is higher than a remainder of the composite scores 712 and assign a second candidate genealogical record that corresponds to the second relatively highest score a rank of second. The record-linking system 102 can iteratively continue to assign ranks to the set of candidate genealogical records according to their relative composite scores.

As shown in FIG. 7, based on determining the ranking 714, the record-linking system 102 can generate a link 720 between a source genealogical record and a target genealogical record. Indeed, the record-linking system 102 can generate the link 720 by selecting a candidate genealogical record from the set of the candidate genealogical records. For example, the record-linking system 102 can select the candidate genealogical record by selecting the candidate genealogical record with the rank of first from the ranking 714. The record-linking system 102 can further compare the candidate genealogical record to a predetermined threshold. For example, the predetermined threshold can be a numerical value that indicates a level of certainty that the candidate genealogical record corresponds to a source genealogical record. Based on determining that the candidate genealogical record meets or exceeds the predetermined threshold, the record-linking system 102 can perform an act of linking the candidate genealogical record to the source genealogical record to generate the link 720.

As previously mentioned, in some embodiments the record-linking system 102 can determine a link at least based in part on identifying contextual data or contextual features associated with a set of genealogical records. FIGS. 8A-8B illustrate the record-linking system 102 extracting and comparing contextual data in accordance with one or more embodiments.

As shown in FIG. 8A, the record-linking system 102 can extract contextual data from a source genealogical record 801. As used herein, the term “contextual data” or “contextual feature” can refer to data or features that are shared features among the set of genealogical records, data or features shared between one or more target genealogical records and the source genealogical record, and/or data or features shared among one or more candidate genealogical records and the source genealogical records. For example, contextual data can refer to data relating to populations within a geographic area at different periods of time. For instance, the contextual data can be first population data relating to a geographic location for a first period of time for a source genealogical record and second population data relating to the geographic location for a second period of time.

As shown in FIG. 8A, the record-linking system 102 can determine the contextual data from the source genealogical record 801 (e.g., a census record from 1940) by identifying a geographical area for a first time period 802 (e.g., such as a 1940 city). Further, the record-linking system 102 can determine the contextual data from the source genealogical record 801 by extracting or otherwise determining population data 804 for the 1940 city. The record-linking system 102 can further determine or otherwise identify a source individual 806 corresponding to the source genealogical record as well as a birth date for the source individual (e.g., “John Doe Born 1912”).

As shown in FIG. 8A, the record-linking system 102 can further extract or otherwise determine contextual data from a candidate genealogical record 807 (e.g., a census record from 1930) by identifying the geographical area for a second time period 808 (e.g., such as a 1930 city). The record-linking system 102 can further determine the contextual data from the candidate genealogical record 807 by extracting or otherwise determining population data 810 for the 1930 city. In addition, the record-linking system 102 can identify a candidate individual 812 from the population data for the 1930 city (e.g., John Doe Born 1912).

Indeed, the record-linking system 102 can compare data for the geographical area for the first time period 802 with data for the geographical area for the second time period 808 to determine overlapping contextual data from the two records. For example, the record-linking system 102 can determine that the geographical areas are a same geographical area (e.g., that the 1940 city is the same as the 1930 city). Further, the record-linking system 102 can determine a temporal difference between the contextual data from the source genealogical record 801 and the contextual data from the candidate genealogical record 807, such as by determining a difference between the first time period and the second time period (e.g., the difference between 1940 and 1930, or ten years). Additionally, the record-linking system 102 can compare the population data 804 for the source genealogical record with the population data 810 for the candidate genealogical record to determine a level of similarity between the population data 804 and the population data 810.

Based on extracting and comparing the contextual data from the source genealogical record 801 with the contextual data for the candidate genealogical record, the record-linking system 102 can determine that the candidate individual 812 is the source individual 806 and can link the source genealogical record to the candidate genealogical record accordingly.

In addition to comparing contextual data for geographical locations, such as cities, from different time periods, the record-linking system 102 can compare contextual data, such as household records, for different time periods. FIG. 8B illustrates the record-linking system 102 comparing contextual data for households in accordance with one or more embodiments.

As shown in FIG. 8B, the record-linking system 102 can extract contextual data from a source genealogical record 860. The contextual data from the source genealogical record 860 can include household data for a first time period 850 (e.g., a 1940 household). Indeed, the record-linking system 102 can analyze the household data for the first time period 850 to determine members of the household 852 for the first time period. Further, the record-linking system 102 can extract contextual data from a candidate genealogical record 862. The contextual data from the candidate genealogical record 862 can include household data for a second time period 854. The record-linking system 102 can analyze the household data for the second time period 854 to determine members of the household 856 for the second time period 854.

The record-linking system 102 can analyze additional types of contextual data to determine links. For example, the record-linking system 102 can use similarity scores (e.g., that the record-linking system 102 generates using a second machine learning model) to inform or otherwise generate contextual data. For example, the record-linking system 102 can extract contextual data by determining a difference between a maximum similarity score of a set of similarity scores for candidate genealogical records and a similarity score for a particular candidate genealogical record. Further, the record-linking system 102 can extract contextual data by determining birth year differences between source and target genealogical records, determining state, county, and/or city matches between source and candidate genealogical records, determining household generation matches between source and candidate genealogical records (e.g., as discussed above), and/or determining migration scores between source and candidate genealogical records, among others.

Based on extracting the household data for the first time period 850, the household data for the second time period 854, the members of the household 852 for the first time period, and the members of the household 856 for the second time period, the record-linking system 102 can compare the extracted data to determine that the household data for the different time periods corresponds to a same family. For example, the record-linking system 102 can compare the members of the household 852 for the first time period 850 to the members of the household 856 for the second time period 854 to determine an overlapping family composition between the two time periods. For example, the record-linking system 102 can determine a first individual corresponding to a mother, a second individual corresponding to a father, a third individual corresponding to a son, and a fourth individual corresponding to a daughter for both time periods. Additionally, the record-linking system 102 can identify a fifth individual in the household data for the first time period 850. The record-linking system 102 can compare the first time period to the second time period to determine a difference between the first time period and the second time period (e.g., the record-linking system 102 can determine that the second time period is ten years prior to the first time period). Due to determining the difference between the first time period and the second time period, the record-linking system 102 can determine that the fifth individual corresponds to a second son.

Indeed, as the preceding discussion of FIGS. 8A-8B indicate, the record-linking system 102 can use the contextual data to determine a link between a candidate genealogical record and a source genealogical record. By identifying shared or otherwise overlapping context between the candidate genealogical record and the source genealogical record, the record-linking system 102 can use the overlapping context to generate a match likelihood score. Indeed, the record-linking system 102 can identify and analyze contextual data to augment the process of determining a link between a source genealogical record and a candidate genealogical record beyond solely relying on matches in field data.

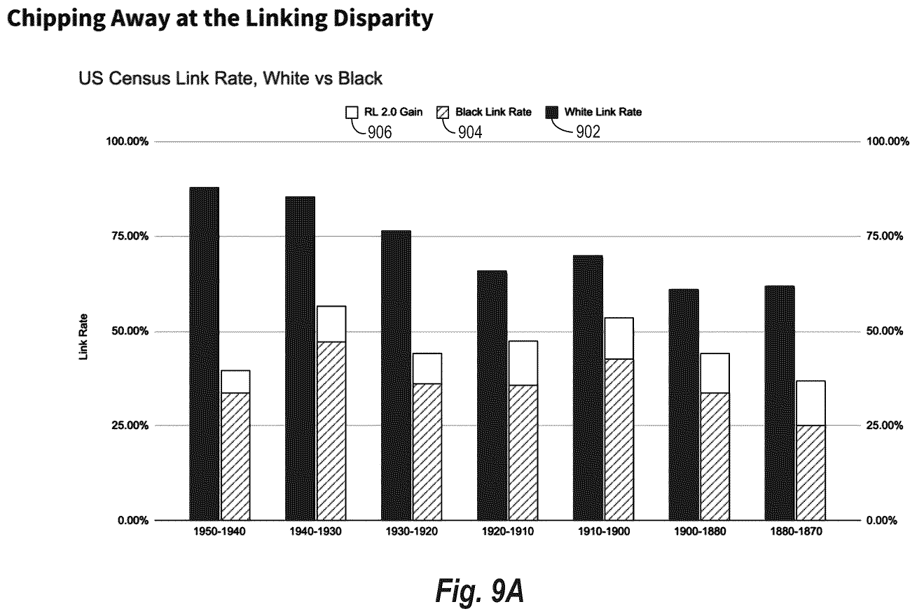

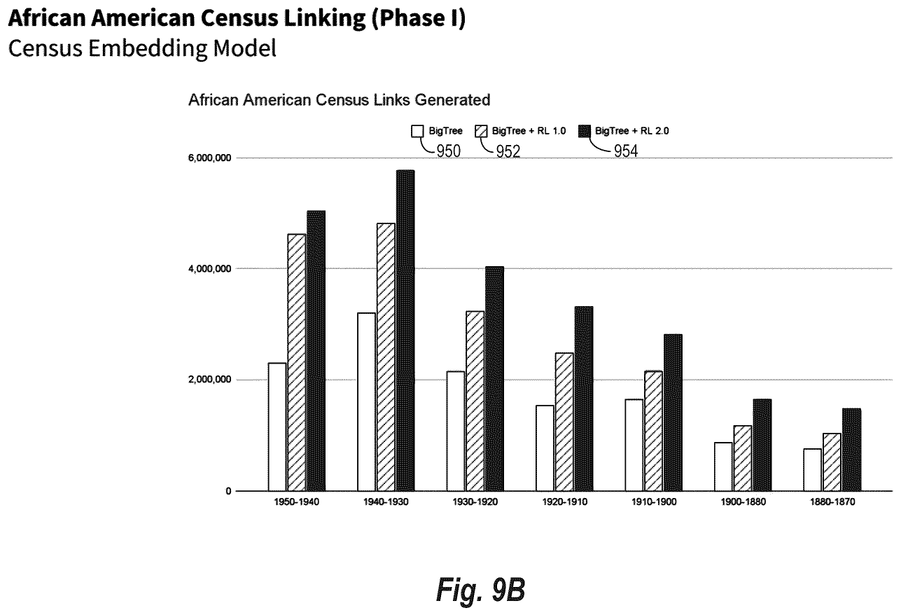

As previously mentioned, the record-linking system 102 can provide improved accuracy compared to prior systems by identifying links that prior systems do not capture. FIGS. 9A-9B illustrate experimental results achieved by the record-linking system 102 in accordance with one or more embodiments.

FIG. 9A illustrates link determination rates for different time periods. For example, FIG. 9A illustrates a first set of link rates 902 achieved by the record-linking system 102 for a first demographic of target genealogical records across multiple time periods (e.g., “White Link Rate” for the years 1950-1940, 1940-1930, 1930-1920, 1920-1910, 1910-1900, 1900-1880, and 1880-1870). Additionally, FIG. 9A illustrates a second set of link rates 904 achieved by prior systems for a second demographic of target genealogical records across the multiple time periods (e.g., “Black Link Rate”). As previously mentioned, and as illustrated by the disparity between the first set of link rates 902 and the second set of link rates 904, conventional systems often fail to generate links due to inaccurate or insufficient data reflecting real-life events for certain records (e.g., of sparse record types or for underrepresented groups). These failures can be exacerbated within different population demographics due to factors such as disparate historical treatment of certain demographic groups.

As shown in FIG. 9A, the record-linking system 102 can provide improvements 906 to the second set of link rates 904 for the second demographic of genealogical records. Indeed, by accounting for factors such as contextual data and flexibly identifying links between source genealogical records and candidate genealogical records using the processes described herein, the record-linking system 102 can generate links that conventional systems miss.

FIG. 9B provides additional insights on improvements achieved by the record-linking system 102 as demonstrated by experimental results. Indeed, FIG. 9B illustrates a first set of link metrics 950 achieved by prior systems (e.g., “BigTree”) for a first demographic (e.g., African Americans) for multiple time periods (e.g., for the years 1950-1940, 1940-1930, 1930-1920, 1920-1910, 1910-1900, 1900-1880, and 1880-1870). Additionally, FIG. 9B illustrates a second set of link metrics 952 achieved by a other prior systems that attempt to perform record linking (e.g., BigTree+RL 1.0) for the first demographic the multiple time periods. Further, FIG. 9B illustrates a third set of link metrics 954 achieved by the record-linking system 102 (e.g., BigTree+RL 2.0) for the first demographic for the multiple time periods. Indeed, as illustrated by the sets of link metrics achieved by both the first and second experimental embodiments of the record-linking system, the record-linking system 102 improves accuracy compared to conventional systems by generating links that conventional systems miss.

FIG. 10 illustrates a genealogical-data system 1000 interfacing with a genealogical database 1002 in accordance with one or more embodiments. For certain genealogical databases, the genealogical-data system 1000 identifies groups of user nodes or records in the format of a genealogical tree or records connected by biological and other family relationships as “tree data.” The genealogical-data system 1000 can thus search and process tree data stored in a genealogical database 1002 (which includes a tree database 1004 and a cluster database 1006) to execute tasks and perform functions as described herein.

In one or more embodiments, the genealogical-data system 1000 can resolve duplicate entities corresponding to respective genealogical records. Indeed, the genealogical-data system 1000 can determine that two entities in a cluster database are the same individual, despite differences in various data, such as name spelling, discrepancies in certain dates, and/or other variances in data. The genealogical-data system 1000 can analyze clusters of genealogical records stored for each individual within the cluster database 1006 to determine that the clusters are within a threshold similarity of one another and that, therefore, the clusters should be combined or otherwise resolved to represent a single individual. In some cases, the genealogical-data system 1000 can compare clusters by extracting vectors from the genealogical records in the clusters, averaging the vectors to generate cluster vectors (or otherwise determining weighted or unweighted cluster centers) representative of respective clusters, and determining distances (e.g., Euclidean or cosine distances) between the cluster vectors. The genealogical-data system 1000 can further propagate such entity resolution to the tree database 1004 to update nodes and edges within a universal genealogical tree, resolving two previously disparate nodes into a single node as indicated by the newly resolved (or combined clusters in the cluster database 1006.

For the genealogical database 1002, the genealogical-data system 1000 may receive genealogical data (e.g., data records and/or genealogical data objects) for building tree data from a source selected from a ground-truth genealogical tree generated from genealogical records and trees of user accounts within the genealogical-data system 1000, from the Ancestry World Tree system, a Social Security Death Index database, the World Family Tree system, a birth certificate database, a death certificate database, a marriage certificate database, an adoption database, a draft registration database, a veterans database, a military database, a property records database, a census database, a voter registration database, a phone database, an address database, a newspaper database, an immigration database, a family history records database, a local history records database, a business registration database, and/or a motor vehicle database. Additionally, genealogical data can be user-generated. Genealogical data may also include data from a cluster database 1006 derived from records and user data.

Some embodiments of the record-linking system 102 relate to modifying a cluster database 1006 based on a user query and/or other interaction with the record-linking system 102. In some instances, the genealogical-data system 1000 (or the record-linking system 102) determines and/or modifies a node connection for an individual represented by or resolved to a cluster within the cluster database 1006. Indeed, the record-linking system 102 can analyze, add, remove, and/or modify genealogical content items organized into clusters within the cluster database 1006 based on relatedness corresponding to a common individual. The record-linking system 102 can also access, modify, and analyze genealogical trees within the tree database 1004 by, for example, adding nodes, removing nodes, and/or modifying nodes based on genealogical content items (and their relationships to individuals) stored within the cluster database 1006.

As seen in FIG. 10, the genealogical-data system 1000 includes a genealogical database 1002, which may include a tree database 1004 and a cluster database 1006. The tree database 1004 may be configured to facilitate the generation, storage, and collation of family trees for a plurality of users, with trees comprising nodes and edges therebetween. Data and records, such as images, may be associated with individual nodes of the trees in the tree database 1004. Tree person data, including data such as names, relationships, dates, events, and other metadata may be provided by the tree database 1004 to the genealogical-data system 1000. The cluster database 1006 may include one or more clusters comprising resolved entities, where tree persons (nodes) in different trees in the tree database 1004 are associated together in a cluster after determination that the tree persons correspond to a same person.

As a user expands their family tree, the tree database 1004 may be modified as the user's family tree is expanded, and the cluster database 1006 may be modified to include the new node in the pertinent cluster. For example, the record-linking system 102 can modify the cluster database 1006 to include a new node responsive to determining a link between a source genealogical record and a target genealogical record (and/or a candidate genealogical record). Indeed, the record-linking system 102 can generate the new node to correspond to an entity that the record-linking system 102 extracts and links from the source genealogical record and the target genealogical record. Further, the record-linking system 102 can attach a conversation with a user account (e.g., a query received from the user account and a response the record-linking system 102 generates, and/or a series of queries and corresponding responses) to a cluster within the cluster database 1006 and/or a node within the tree database 1004 to utilize as a ground-truth genealogical tree for future operations within the genealogical-data system 1000. For example, the record-linking system 102 can extract or otherwise pull contextual data from the user account or conversations with the user account and attach the context to a node or a cluster of the cluster database 1006 to utilize as a ground-truth genealogical tree for future operations within the genealogical-data system 1000 and/or the record-linking system 102.

FIGS. 1-10, the corresponding text, and the examples provide a number of different systems and methods for determining a link between a source genealogical record and a candidate genealogical record in accordance with one or more embodiments. In addition to the foregoing, implementations can also be described in terms of flowcharts comprising acts and/or steps in a method for accomplishing a particular result. For example, FIG. 11 illustrates an example series of acts for determining a link between a source genealogical record and a candidate genealogical record in accordance with one or more embodiments.

While FIG. 11 illustrates acts according to certain implementations, alternative implementations may omit, add to, reorder, and/or modify any of the acts shown in FIG. 11. The acts of FIG. 11 can be performed as part of a computer-implemented method. Alternatively, a non-transitory computer-readable medium can comprise instructions that, when executed by one or more processors, cause a computing device to perform the acts of FIG. 11. In still further implementations, a system can perform the acts of FIG. 11.

As illustrated, the series of acts 1100 can include an act 1102 of converting a set of genealogical records into embeddings. Specifically, the act 1102 can include converting a set of genealogical records into embeddings using a first machine learning model. Additionally, the series of acts 1100 can include an act 1104 of comparing embeddings in a latent space of a first machine learning model. Specifically, the act 1104 can include comparing, among the embeddings of the set of genealogical records, embeddings of target genealogical records to an embedding of a source genealogical record in a latent space of the first machine learning model. Further, the series of acts 1100 can include an act 1106 of identifying a set of candidate genealogical records. Specifically, the act 1106 can include identifying a set of candidate genealogical records based on comparing the embeddings of target genealogical records to the embedding of the source genealogical record. In addition, the series of acts 1100 can include an act 1108 of applying a second machine learning model to generate similarity scores. Specifically, the act 1108 can include applying a second machine learning model to generate similarity scores by comparing field similarities between the set of candidate genealogical records and the source genealogical record. Moreover, the series of acts 1100 can include an act 1110 of applying a third machine learning model to generate a match likelihood score. Specifically, the act 1110 can include generating, based on applying a third machine learning model that processes contextual data associated with the set of candidate genealogical records, a match likelihood score that indicates a likelihood of a match between a candidate genealogical record from the set of candidate genealogical records and the source genealogical record. Additionally, the series of acts 1100 can include an act 1112 of determining a link. Specifically, the act 1112 can include determining a link between the source genealogical record and a target genealogical record of the target genealogical records based on the similarity scores and the match likelihood score.

Furthermore, in one or more embodiments, the series of acts 1100 can include converting the set of records into the embeddings by: generating, in parallel, input strings for each genealogical record; inputting, in parallel, the input strings into the first machine learning model; and generating an embedding for each genealogical record, wherein each embedding is configured such that genealogical records of the set of genealogical records corresponding to a same entity have embedding values within a proximity threshold of each other in the latent space.

In addition, in some embodiments, the series of acts 1100 can include comparing the embeddings of the target genealogical records to the embedding of the source genealogical record by performing a search to identify the embeddings of the target genealogical records that are within a threshold distance of the embedding of the source genealogical record in the latent space.

Moreover, in one or more embodiments, the series of acts 1100 can include selecting, as the set of candidate genealogical records, a predetermined number of target genealogical records whose embeddings are within a threshold distance of the embedding of the source genealogical record in the latent space.

Additionally, in some embodiments the series of acts 1100 can include applying the second machine learning model by extracting field data from a candidate genealogical record of the set of candidate genealogical records and the source genealogical record, wherein the field data includes any one of: name information, family member information, birth year information, birth place information, or occupation information. Indeed, the series of acts 1100 can include inputting the field data into the second machine learning model. Further, the series of acts 1100 can include comparing, by the second machine learning model, the field data of the candidate genealogical record with the field data of the source genealogical record. Moreover, the series of acts 1100 can include generating, by the second machine learning model, a prediction that indicates a level of correspondence between the candidate genealogical record and the source genealogical record.

Further, in one or more embodiments the series of acts 1100 can include applying the third machine learning model by extracting contextual data related to a candidate genealogical record of the set of candidate genealogical records and the source genealogical record. Indeed, the series of acts 1100 can include generating combined data by combining the contextual data with the similarity scores. Additionally, the series of acts 1100 can include inputting the combined data into the third machine learning model. Furthermore, the series of acts 1100 can include generating, by the third machine learning model, a match likelihood score indicating a probability measure that the candidate genealogical record and the source genealogical record correspond to a same entity.

In addition, in some embodiments the contextual data can include one or more of: a source score difference, a household link indicator, a birth year difference, a state match indicator, a household given name match count, a source candidate count, a surname phonetic similarity score, a surname string similarity score, a migration score, a given name string similarity score, a target candidate count, a given name phonetic similarity score, a county match indicator, or a city match indicator.

Moreover, in one or more embodiments the series of acts 1100 can include generating, by the second machine learning model, a set of predictions that indicate a level of correspondence between each candidate genealogical record of the set of candidate genealogical records and the source genealogical record. Indeed, the series of acts 1100 can include combining the set of predictions from the second machine learning model and the match likelihood score from the third machine learning model to generate a composite score for each candidate genealogical record. Moreover, the series of acts 1100 can include determining a ranking of the set of candidate genealogical records based on their respective composite scores. Additionally, the series of acts 1100 can include selecting a candidate genealogical record of the set of candidate genealogical records based on the ranking. Further, the series of acts 1100 can include comparing the composite score of the candidate genealogical record to a predetermined threshold. Furthermore, the series of acts 1100 can include, responsive to determining that the composite score exceeds the predetermined threshold, linking on a database the source genealogical record and the candidate genealogical record.

In addition, in some embodiments the series of acts 1100 can include performing a deduplication process to prevent the source genealogical record from being linked to multiple candidate genealogical records.

Furthermore, in one or more embodiments, the series of acts 1100 can include performing the deduplication process by identifying a set of linked candidate genealogical records that have been linked to the source genealogical record based on their composite score exceeding a predetermined threshold. Indeed, the series of acts 1100 can include comparing composite scores of the set of linked candidate genealogical records. Additionally, the series of acts 1100 can include selecting a linked genealogical record of the set of linked candidate genealogical records based on comparing the composite scores of the set of linked candidate genealogical records. Moreover, the series of acts 1100 can include updating a database to maintain the link between the source genealogical record and the linked genealogical record, and removing links between the source genealogical record and non-selected linked candidate genealogical records.

### Computing Machine Architecture

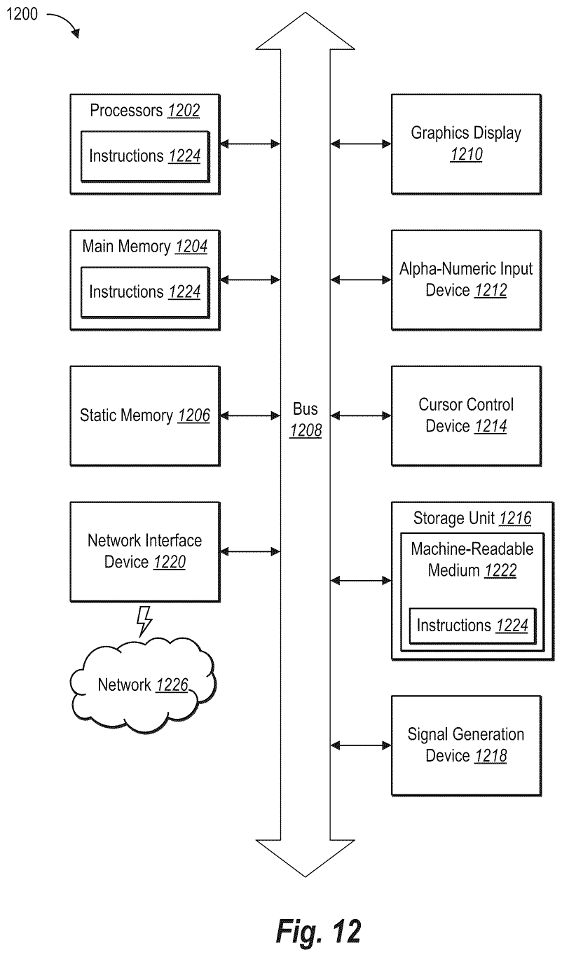

FIG. 12 is a block diagram illustrating components of an example computing machine that is capable of reading instructions from a computer-readable medium and executing them in a processor (or controller). A computer described herein may include a single computing machine shown in FIG. 12, a virtual machine, a distributed computing system that includes multiple nodes of computing machines shown in FIG. 12, or any other suitable arrangement of computing devices.

By way of example, FIG. 12 shows a diagrammatic representation of a computing machine in the example form of a computer system 1200 within which instructions 1224 (e.g., software, source code, program code, expanded code, object code, assembly code, or machine code), which may be stored in a computer-readable medium for causing the machine to perform any one or more of the processes discussed herein may be executed. In some embodiments, the computing machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The structure of a computing machine described in FIG. 12 may correspond to any software, hardware, or combined components shown in FIGS. 1 and 2, including but not limited to, the client device 110, the computing server 130, and various engines, interfaces, terminals, and machines shown in FIG. 2. While FIG. 12 shows various hardware and software elements, each of the components described in FIGS. 1 and 2 may include additional or fewer elements.

By way of example, a computing machine may be a personal computer (PC), a tablet PC, a set-top box (STB), a personal digital assistant (PDA), a cellular telephone, a smartphone, a web appliance, a network router, an internet of things (IoT) device, a switch or bridge, or any machine capable of executing instructions 1224 that specify actions to be taken by that machine. Further, while only a single machine is illustrated, the terms “machine” and “computer” may also be taken to include any collection of machines that individually or jointly execute instructions 1224 to perform any one or more of the methodologies discussed herein.

The example computer system 1200 includes one or more processors 1202 such as a CPU (central processing unit), a GPU (graphics processing unit), a TPU (tensor processing unit), a DSP (digital signal processor), a system on a chip (SOC), a controller, a state equipment, an application-specific integrated circuit (ASIC), a field-programmable gate array (FPGA), or any combination of these. Parts of the computing system 1200 may also include a memory 1204 that stores computer code including instructions 1224 that may cause the processors 1202 to perform certain actions when the instructions are executed, directly or indirectly by the processors 1202. Instructions can be any directions, commands, or orders that may be stored in different forms, such as equipment-readable instructions, programming instructions including source code, and other communication signals and orders. Instructions may be used in a general sense and are not limited to machine-readable codes. One or more steps in various processes described may be performed by passing through instructions to one or more multiply-accumulate (MAC) units of the processors.

One or more methods described herein improve the operation speed of the processor 1202 and reduce the space required for the memory 1204. For example, the database processing techniques and machine learning methods described herein reduce the complexity of the computation of the processors 1202 by applying one or more novel techniques that simplify the steps in training, reaching convergence, and generating results of the processors 1202. The algorithms described herein also reduce the size of the models and datasets to reduce the storage space requirement for memory 1204.

The performance of certain operations may be distributed among more than one processor, not only residing within a single machine, but deployed across a number of machines. In some example embodiments, the one or more processors or processor-implemented modules may be located in a single geographic location (e.g., within a home environment, an office environment, or a server farm). In other example embodiments, one or more processors or processor-implemented modules may be distributed across a number of geographic locations. Even though the specification or the claims may refer to some processes to be performed by a processor, this may be construed to include a joint operation of multiple distributed processors. In some embodiments, a computer-readable medium comprises one or more computer-readable media that, individually, together, or distributedly, comprise instructions that, when executed by one or more processors, cause the one or more processors to perform, individually, together, or distributedly, the steps of the instructions stored on the one or more computer-readable media. Similarly, a processor comprises one or more processors or processing units that, individually, together, or distributedly, perform the steps of instructions stored on a computer-readable medium. In various embodiments, the discussion of one or more processors that carry out a process with multiple steps does not require any one of the processors to carry out all of the steps. For example, a processor A can carry out step A, a processor B can carry out step B using, for example, the result from the processor A, and a processor C can carry out step C, etc. The processors may work cooperatively in this type of situation such as in multiple processors of a system in a chip, in Cloud computing, or in distributed computing.

The computer system 1200 may include a main memory 1204, and a static memory 1206, which are configured to communicate with each other via a bus 1208. The computer system 1200 may further include a graphics display unit 1210 (e.g., a plasma display panel (PDP), a liquid crystal display (LCD), a projector, or a cathode ray tube (CRT)). The graphics display unit 1210, controlled by the processor 1202, displays a graphical user interface (GUI) to display one or more results and data generated by the processes described herein. The computer system 1200 may also include an alphanumeric input device 1212 (e.g., a keyboard), a cursor control device 1214 (e.g., a mouse, a trackball, a joystick, a motion sensor, or other pointing instruments), a storage unit 1216 (a hard drive, a solid-state drive, a hybrid drive, a memory disk, etc.), a signal generation device 1218 (e.g., a speaker), and a network interface device 1220, which also are configured to communicate via the bus 1208.

The storage unit 1216 includes a computer-readable medium 1222 on which is stored instructions 1224 embodying any one or more of the methodologies or functions described herein. The instructions 1224 may also reside, completely or at least partially, within the main memory 1204 or within the processor 1202 (e.g., within a processor's cache memory) during execution thereof by the computer system 1200, the main memory 1204 and the processor 1202 also constituting computer-readable media. The instructions 1224 may be transmitted or received over a network 1226 via the network interface device 1220.

While computer-readable medium 1222 is shown in an example embodiment to be a single medium, the term “computer-readable medium” should be taken to include a single medium or multiple media (e.g., a centralized or distributed database, or associated caches and servers) able to store instructions (e.g., instructions 1224). The computer-readable medium may include any medium that is capable of storing instructions (e.g., instructions 1224) for execution by the processors (e.g., processors 1202) and that cause the processors to perform any one or more of the methodologies disclosed herein. The computer-readable medium may include, but not be limited to, data repositories in the form of solid-state memories, optical media, and magnetic media. The computer-readable medium does not include a transitory medium such as a propagating signal or a carrier wave.

### Additional Considerations

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Any feature mentioned in one claim category, e.g. method, can be claimed in another claim category, e.g. computer program product, system, or storage medium, as well. The dependencies or references in the attached claims are chosen for formal reasons only. However, any subject matter resulting from a deliberate reference back to any previous claims (in particular multiple dependencies) can be claimed as well, so that any combination of claims and the features thereof is disclosed and can be claimed regardless of the dependencies chosen in the attached claims. The subject matter may include not only the combinations of features as set out in the disclosed embodiments but also any other combination of features from different embodiments. Various features mentioned in the different embodiments can be combined with explicit mentioning of such combination or arrangement in an example embodiment or without any explicit mentioning. Furthermore, any of the embodiments and features described or depicted herein may be claimed in a separate claim and/or in any combination with any embodiment or feature described or depicted herein or with any of the features.

Some portions of this description describe the embodiments in terms of algorithms and symbolic representations of operations on information. These operations and algorithmic descriptions, while described functionally, computationally, or logically, are understood to be implemented by computer programs or equivalent electrical circuits, microcodes, or the like. Furthermore, it has also proven convenient at times, to refer to these arrangements of operations as engines, without loss of generality. The described operations and their associated engines may be embodied in software, firmware, hardware, or any combinations thereof.

Any of the steps, operations, or processes described herein may be performed or implemented with one or more hardware or software engines, alone or in combination with other devices. In some embodiments, a software engine is implemented with a computer program product comprising a computer-readable medium containing computer program code, which can be executed by a computer processor for performing any or all of the steps, operations, or processes described. The term “steps” does not mandate or imply a particular order. For example, while this disclosure may describe a process that includes multiple steps sequentially with arrows present in a flowchart, the steps in the process do not need to be performed in the specific order claimed or described in the disclosure. Some steps may be performed before others even though the other steps are claimed or described first in this disclosure. Likewise, any use of (i), (ii), (iii), etc., or (a), (b), (c), etc. in the specification or in the claims, unless specified, is used to better enumerate items or steps and also does not mandate a particular order.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. In addition, the term “each” used in the specification and claims does not imply that every or all elements in a group need to fit the description associated with the term “each.” For example, “each member is associated with element A” does not imply that all members are associated with an element A. Instead, the term “each” only implies that a member (of some of the members), in a singular form, is associated with an element A. In claims, the use of a singular form of a noun may imply at least one element even though a plural form is not used.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights.

The following applications are incorporated by reference in their entirety for all purposes: (1) U.S. Pat. No. 10,679,729, entitled “Haplotype Phasing Models,” granted on Jun. 9, 2020, (2) U.S. Pat. No. 10,223,498, entitled “Discovering Population Structure from Patterns of Identity-By-Descent,” granted on Mar. 5, 2019, (3) U.S. Pat. No. 10,720,229, entitled “Reducing Error in Predicted Genetic Relationships,” granted on Jul. 21, 2020, (4) U.S. Pat. No. 10,558,930, entitled “Local Genetic Ethnicity Determination System,” granted on Feb. 11, 2020, (5) U.S. Pat. No. 10,114,922, entitled “Identifying Ancestral Relationships Using a Continuous Stream of Input,” granted on Oct. 30, 2018, (6) U.S. Pat. No. 11,429,615, entitled “Linking Individual Datasets to a Database,” granted on Aug. 30, 2022, (7) U.S. Pat. No. 10,692,587, entitled “Global Ancestry Determination System,” granted on Jun. 23, 2020, and (8) U.S. Patent Application Publication No. US 2021/0034647, entitled “Clustering of Matched Segments to Determine Linkage of Dataset in a Database,” published on Feb. 4, 2021.

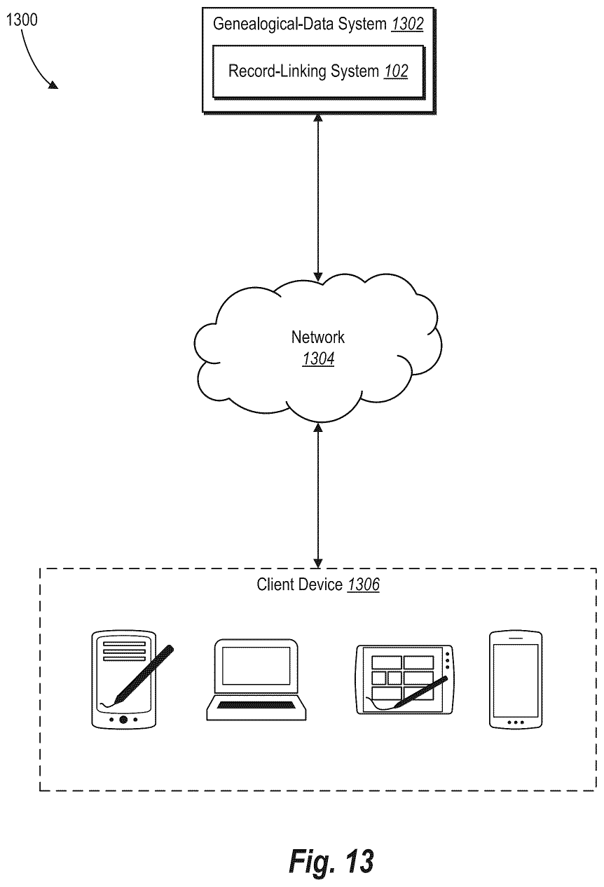

FIG. 13 is a schematic diagram illustrating environment 1300 within which one or more implementations of the record-linking system 102 can be implemented. For example, the record-linking system 102 may be part of a genealogical-data system 1302. The genealogical-data system 1302 may generate, store, manage, receive, and send digital content (such as genealogical records). For example, genealogical-data system 1302 may send and receive digital content to and from client devices 1306 by way of network 1304. In particular, genealogical-data system 1302 can store and manage genealogical databases for various user accounts, historical records, and genealogical trees. In some embodiments, the genealogical-data system 1302 can manage the distribution and sharing of digital content between computing devices associated with user accounts. For instance, the genealogical-data system 1302 can facilitate a user account sharing a genealogical record with another user account of genealogical-data system 1302.

In particular, the genealogical-data system 1302 can manage synchronizing digital content across multiple client devices 1306 associated with one or more user accounts. For example, a user may edit a digitized historical document or a node within a genealogical tree using client device 1306. The genealogical-data system 1302 can cause client device 1306 to send the edited genealogical content to the genealogical-data system 1302, whereupon the genealogical-data system 1302 synchronizes the genealogical content on one or more additional computing devices.

As shown, the client device 1306 may be a desktop computer, a laptop computer, a tablet computer, an augmented reality device, a virtual reality device, a personal digital assistant (PDA), an in- or out-of-car navigation system, a handheld device, a smart phone or other cellular or mobile phone, or a mobile gaming device, other mobile device, or other suitable computing devices. The client device 1306 may execute one or more client applications, such as a web browser (e.g., Microsoft Windows Internet Explorer, Mozilla Firefox, Apple Safari, Google Chrome, Opera, etc.) or a native or special-purpose client application (e.g., Ancestry: Family History & DNA for iPhone or iPad, Ancestry: Family History & DNA for Android, etc.), to access and view content over the network 1304.

The network 1304 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which client devices 1306 may access genealogical-data system 1302.

In the foregoing specification, the present disclosure has been described with reference to specific exemplary implementations thereof. Various implementations and aspects of the present disclosure(s) are described with reference to details discussed herein, and the accompanying drawings illustrate the various implementations. The description above and drawings are illustrative of the disclosure and are not to be construed as limiting the disclosure. Numerous specific details are described to provide a thorough understanding of various implementations of the present disclosure.

The present disclosure may be embodied in other specific forms without departing from its spirit or essential characteristics. The described implementations are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

The foregoing specification is described with reference to specific exemplary implementations thereof. Various implementations and aspects of the disclosure are described with reference to details discussed herein, and the accompanying drawings illustrate the various implementations. The description above and drawings are illustrative and are not to be construed as limiting. Numerous specific details are described to provide a thorough understanding of various implementations.

The additional or alternative implementations may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
converting a set of genealogical records into embeddings using a first machine learning model;
comparing, among the embeddings of the set of genealogical records, embeddings of target genealogical records to an embedding of a source genealogical record in a latent space of the first machine learning model;
identifying a set of candidate genealogical records based on comparing the embeddings of target genealogical records to the embedding of the source genealogical record;
applying a second machine learning model to generate similarity scores by comparing field similarities between the set of candidate genealogical records and the source genealogical record;
generating, based on applying a third machine learning model that processes contextual data associated with the set of candidate genealogical records, a match likelihood score that indicates a likelihood of a match between a candidate genealogical record from the set of candidate genealogical records and the source genealogical record; and
determining a link between the source genealogical record and a target genealogical record of the target genealogical records based on the similarity scores and the match likelihood score.

2. The computer-implemented method of claim 1, wherein converting the set of genealogical records into the embeddings comprises:
generating, in parallel, input strings for each genealogical record;
inputting the input strings into the first machine learning model; and
parallelly generating, using the first machine learning model, an embedding for each genealogical record, wherein each embedding is configured such that genealogical records of the set of genealogical records corresponding to a same entity have embedding values within a proximity threshold of each other in the latent space.

3. The computer-implemented method of claim 1, wherein comparing the embeddings of the target genealogical records to the embedding of the source genealogical record comprises:
performing a search to identify the embeddings of the target genealogical records that are within a threshold distance of the embedding of the source genealogical record in the latent space.

4. The computer-implemented method of claim 1, wherein identifying the set of candidate genealogical records comprises:
selecting, as the set of candidate genealogical records, a predetermined number of target genealogical records whose embeddings are within a threshold distance of the embedding of the source genealogical record in the latent space.

5. The computer-implemented method of claim 1, wherein applying the second machine learning model comprises:
extracting field data from a candidate genealogical record of the set of candidate genealogical records and the source genealogical record, wherein the field data includes any one of:
name information,
family member information,
birth year information,
birth place information, or
occupation information;
inputting the field data into the second machine learning model;
comparing, by the second machine learning model, the field data of the candidate genealogical record with the field data of the source genealogical record; and
generating, by the second machine learning model, a prediction that indicates a level of correspondence between the candidate genealogical record and the source genealogical record.

6. The computer-implemented method of claim 1, wherein applying the third machine learning model comprises:
extracting contextual data related to a candidate genealogical record of the set of candidate genealogical records and the source genealogical record;
generating combined data by combining the contextual data with the similarity scores;
inputting the combined data into the third machine learning model; and
generating, by the third machine learning model, a match likelihood score indicating a probability measure that the candidate genealogical record and the source genealogical record correspond to a same entity.

7. The computer-implemented method of claim 1, wherein the contextual data comprises any one of: a source score difference, a household link indicator, a birth year difference, a state match indicator, a household given name match count, a source candidate count, a surname phonetic similarity score, a surname string similarity score, a migration score, a given name string similarity score, a target candidate count, a given name phonetic similarity score, a county match indicator, or a city match indicator.

8. The computer-implemented method of claim 1, wherein determining the link between the source genealogical record and the target genealogical record comprises:
generating, by the second machine learning model, a set of predictions that indicate a level of correspondence between each candidate genealogical record of the set of candidate genealogical records and the source genealogical record;
combining the set of predictions from the second machine learning model and the match likelihood score from the third machine learning model to generate a composite score for each candidate genealogical record;
determining a ranking of the set of candidate genealogical records based on their respective composite scores;
selecting a candidate genealogical record of the set of candidate genealogical records based on the ranking;
comparing the composite score of the candidate genealogical record to a predetermined threshold; and
responsive to determining that the composite score exceeds the predetermined threshold, linking on a database the source genealogical record and the candidate genealogical record.

9. The computer-implemented method of claim 1, further comprising performing a deduplication process to prevent the source genealogical record from being linked to multiple candidate genealogical records.

10. The computer-implemented method of claim 9, wherein performing the deduplication process comprises:
identifying a set of linked candidate genealogical records that have been linked to the source genealogical record based on their composite score exceeding a predetermined threshold;
comparing composite scores of the set of linked candidate genealogical records;
selecting a linked genealogical record of the set of linked candidate genealogical records based on comparing the composite scores of the set of linked candidate genealogical records; and
updating a database to maintain the link between the source genealogical record and the linked genealogical record, and removing links between the source genealogical record and non-selected linked candidate genealogical records.

11. A system comprising:
at least one processor; and
at least one non-transitory computer-readable storage medium storing instructions that, when executed by the at least one processor, cause the system to:
convert a set of genealogical records into embeddings using a first machine learning model;
compare, among the embeddings of the set of genealogical records, embeddings of target genealogical records to an embedding of a source genealogical record in a latent space of the first machine learning model;
identify a set of candidate genealogical records based on comparing the embeddings of target genealogical records to the embedding of the source genealogical record;
apply a second machine learning model to generate similarity scores by comparing field similarities between candidate genealogical record and the source genealogical record;
generate, based on applying a third machine learning model that processes contextual data associated with the set of genealogical records, a match likelihood score that indicates a likelihood of a match between a candidate genealogical record from the set of candidate genealogical records and the source genealogical record; and
determine a link between the source genealogical record and a target genealogical record of the target genealogical records based on the similarity scores and the match likelihood score.

12. The system of claim 11, further comprising instructions that, when executed by the at least one processor, cause the system to convert the set of genealogical records into the embeddings by:
generating, in parallel, input strings for each genealogical record;
inputting, in parallel, the input strings into the first machine learning model; and
generating an embedding for each genealogical record, wherein each embedding is configured such that genealogical records of the set of genealogical records corresponding to a same entity have embedding values within a proximity threshold of each other in the latent space.

13. The system of claim 11, further comprising instructions that, when executed by the at least one processor, cause the system to compare the embeddings of the target genealogical records to the embedding of the source genealogical record by:
performing a search to identify the embeddings of the target genealogical records that are within a threshold distance of the embedding of the source genealogical record in the latent space.

14. The system of claim 11, further comprising instructions that, when executed by the at least one processor, cause the system to identify the set of candidate genealogical records by:
selecting, as the set of candidate genealogical records, a predetermined number of target genealogical records whose embeddings are within a threshold distance of the embedding of the source genealogical record in the latent space.

15. The system of claim 11, further comprising instructions that, when executed by the at least one processor, cause the system to apply the second machine learning model by:
extracting field data from a candidate genealogical record of the set of candidate genealogical records and the source genealogical record, wherein the field data includes any one of:
name information,
family member information,
birth year information,
birth place information, or
occupation information;
inputting the field data into the second machine learning model;
comparing, by the second machine learning model, the field data of the candidate genealogical record with the field data of the source genealogical record; and
generating, by the second machine learning model, a prediction that indicates a level of correspondence between the candidate genealogical record and the source genealogical record.

16. A non-transitory computer-readable medium storing instructions that, when executed by at least one processor, cause a computing device to:
convert a set of genealogical records into embeddings using a first machine learning model;
compare, among the embeddings of the set of genealogical records, embeddings of target genealogical records to an embedding of a source genealogical record in a latent space of the first machine learning model;
identify a set of candidate genealogical records based on comparing the embeddings of target genealogical records to the embedding of the source genealogical record;
apply a second machine learning model to generate similarity scores by comparing field similarities between the set of candidate genealogical records and the source genealogical record;
generate, based on applying a third machine learning model that processes contextual data associated with the set of candidate genealogical records, a match likelihood score that indicates a likelihood of a match between a candidate genealogical record from the set of candidate genealogical records and the source genealogical record; and
determine a link between the source genealogical record and a target genealogical record of the target genealogical records based on the similarity scores and the match likelihood score.

17. The non-transitory computer-readable medium of claim 16, further comprising instructions that, when executed by the at least one processor, cause the computing device to:
extract contextual data related to a candidate genealogical record of the set of candidate genealogical records and the source genealogical record;
generate combined data by combining the contextual data with the similarity scores;
input the combined data into the third machine learning model; and
generate, by the third machine learning model, a match likelihood score indicating a probability measure that the candidate genealogical record and the source genealogical record correspond to a same entity.

18. The non-transitory computer-readable medium of claim 16, further comprising instructions that, when executed by the at least one processor, cause the computing device to determine the link between the source genealogical record and the target genealogical record by:
generating, by the second machine learning model, a set of predictions that indicate a level of correspondence between each candidate genealogical record of the set of candidate genealogical records and the source genealogical record;
combining the set of predictions from the second machine learning model and the match likelihood score from the third machine learning model to generate a composite score for each candidate genealogical record;
determining a ranking of the set of candidate genealogical records based on their respective composite scores;
selecting a candidate genealogical record of the set of candidate genealogical records based on the ranking;
comparing the composite score of the candidate genealogical record to a predetermined threshold; and
responsive to determining that the composite score exceeds the predetermined threshold, linking on a database the source genealogical record and the candidate genealogical record.

19. The non-transitory computer-readable medium of claim 18, further comprising instructions that, when executed by the at least one processor, cause the computing device to:
perform a deduplication process to prevent the source genealogical record from being linked to multiple candidate genealogical records.

20. The non-transitory computer-readable medium of claim 19, further comprising instructions that, when executed by the at least one processor, cause the computing device to perform the deduplication process by:
identifying a set of linked candidate genealogical records that have been linked to the source genealogical record based on their composite score exceeding a predetermined threshold;
comparing composite scores of the set of linked candidate genealogical records;
selecting a linked genealogical record of the set of linked candidate genealogical records based on comparing the composite scores of the set of linked candidate genealogical records; and
updating a database to maintain the link between the source genealogical record and the linked genealogical record, and removing links between the source genealogical record and non-selected linked candidate genealogical records.
